(19) United States
(12) Patent Application Publication
(10) Pub. No.: US 2007/0016401 A1
(43) Pub. Date: Jan. 18, 2007

(54) Speech-to-speech translation system with user-modifiable paraphrasing grammars

(76) Inventors: Farzad Ehsani, Sunnyville, CA (US); Demitrios Master, Cupertino, CA (US); Guillaume Proulx, Cupertino, CA (US)

Correspondence Address: EMIL CHANG;LAW OFFICES OF EMIL CHANG, 874 JASMINE DRIVE, SUNNYDALE, CA, 94086, US

(21) Appl. No.: 11/203,621

(22) Filed: Aug. 12, 2005

Related U.S. Application Data
(60) Provisional application No. 60/600,966, filed on Aug. 12, 2004.

(51) Int. Cl. G06F 17/27

(52) U.S. Cl. 704/9

(57) ABSTRACT

The present invention discloses a speech-to-speech translation device which allows one or more users to input a spoken utterance in one language, translates the utterance into one or more second languages, and outputs the translation in speech form. Additionally, the device allows for translation both directions, recognizing inputs in the one or more second languages and translating them back into the first language. The device recognizes and translates utterances in a limited domain as in a phrase book translation system, so the translation accuracy is essentially 100%. By limiting the domain the system increases the accuracy of the speech recognition component and thus the accuracy of the overall system. However unlike other phrase book systems, the device also allows wide variations and paraphrasing in the input, so that the user is much more likely to find the desired phrase from the stored list of phrases. The device paraphrases the input to a basic canonical form and performs the translation on that canonical form, ignoring the non-essential variations in the surface form of the input. The device can provide visual and/or auditory feedback to confirm the recognized input and makes the system usable for non-bilingual users with absolute confidence.

### CROSS REFERENCE

This application claims priority from a United States Provisional Patent Application entitled “A Speech-to-Speech Translation System with User-Modifiable Paraphrasing Grammars” filed on Aug. 12, 2004, having a Provisional Application No. 60/600,966. This application is incorporated herein by reference.

### FIELD OF INVENTION

The present invention relates to speech translation systems, and, in particular, it relates to speech translation systems with grammar.

### BACKGROUND

The task of automatic translation of human language, whether text or speech, has been a research goal for many decades. Until recently, approaches for solving the translation task have taken one of two routes: a full-scale translation engine, which will translate as closely as possible the full breadth of one language into another, or else a phrase translator which translates a limited set of fixed sentences within a highly circumscribed domain, such as travel dialogues.

Full-scale translation engines compose the field which is commonly known as Machine Translation (MT). An MT engine takes a piece of input text in the source language, performs calculations to determine the best translation which prefers the meaning of the input, and outputs the translation in the target language. Machine Translation engines are designed ideally to handle any sentence in the source language, although the actual coverage is limited to the language phenomena that the system designers have anticipated. Translating machines, while a dream for ages, have been a subject of serious research since the 1940's, and today there are a large number of commercial engines covering dozens of language pairs. Among the market leaders in translation engines are Systran (www.systransoft.com), IBM (www-306.ibm.com/software/globalization/topics/machinetranslation/ibm.jsp), and Toshiba (pf.toshiba-sol.co.jp/prod/hon_yaku/index_j.htm).

While the output quality of MT has increased considerably in recent years, these systems are still plagued by many basic problems, including the following:
MT systems have very high error rates which frequently render translation output incomprehensible, or worse, different in meaning from the input sentence.
Because of the high error rate, users who do not have knowledge of the target language are unable to use the system with confidence. Monolingual users distrust the MT systems and will not use them.
MT systems are very brittle, meaning that their performance degrades considerably when the input sentence is even slightly outside of the grammar which the system designers have built into the system. An input which is outside of the prescribed grammar, as is frequently the case with conversational or colloquial language, is analyzed using rules inappropriate for the sentence, so the analysis and translation will be unexpected and unreliable. As above, this inhibits the usability of the system for non-bilingual users who might not realize when the accuracy has degraded significantly.
MT systems rely on extremely complex grammars to do parsing of input sentences and generation of output sentences, so it is essentially impossible for an end-user to update the system grammars. Some MT systems allow the addition of new vocabulary by the user, but not the modification of the underlying grammars.

Phrase translators grew out of the familiar paradigm of phrase books for learning foreign languages. These systems allow a user to select from a limited set of phrases within a constrained domain, often travel-related terminology. The user searches by keyword, navigates a topic hierarchy, or selects from a list to choose a sentence which expresses as closely as possible what he or she wants to communicate. Examples of such electronic phrase books are the Franklin Translator and Communicator (www.franklin.com) and the Lingo Traveler (www.lingodirect.com).

The phrase book paradigm guarantees 100% accuracy and is useful for certain applications, but it has some severe drawbacks which limit their usability, including:
The systems can only translate the exact phrases within the phrase book database. If the user is searching for a phrase which is semantically the same as one in the phrase book, but superficially different (such as “When do you close?” and “Until what time are you open?”), then the user is likely to miss that phrase and be unable to translate the desired input.
Electronic phrase books are not designed to be extensible, so the end user usually cannot add more phrases.
The phrases contained in the phrase book are usually atomic, meaning that full sentences are translated. Or at most, they have one slot which requires the user to complete the output translation him- or herself. For example, a user might use the phrase book to learn that “My name is ______” translates into Spanish as “Me llamo ______” and must then manually substitute in his or her name in order to create the actual output sentence.
Furthermore, in sentence which have these fill-in-the-blank slots, there is no way to limit the class of words or phrases which can be used to fill the slot. Thus a phrase such as “I need to see a ______” might be used inappropriately to match both “I need to see a dentist” and “I need to see a movie”.
The electronic phrase books are intended for the use of the primary user alone, so no translations are provided for responses.

A further limitation of both MT systems and electronic phrase books is that they have been designed to be primarily text-based. The user types in a sentence or feeds in an electronic document and the output translation are returned, also in text form. While attempts have been made to add speech capability on the input and output sides, these efforts have also had significant drawbacks. These drawbacks are primarily due to the fact that the speech recognition on the input side and the voice generation on the output side are separate systems from the translation component. The speech recognition, translation, and voice generation are cascaded to complete the speech-to-speech translation system.

An example of a system which cascades speech recognition with an MT engine is the IBM MASTOR (www.extremetech.com/article2/0,3973,1051637,00.asp) system. Systems which provide a speech interface with a phrase book are the Phraselator (www.phraselator.com) and Ectaco (www.ectaco.com) systems.

These systems have the following drawbacks:
For MT-based systems, the natural error rate of the speech recognition component and the natural error rate of the translation component multiply to produce a system with even lower accuracy and reliability.
For phrase book systems, the constraint of exactly matching the input sentence is even more severe. Human speech has many more natural variations than written language—including contractions, skipped words, and colloquial forms and expressions—so speech input is likely to miss the stored input sentences even more frequently.
For all systems, the systems are designed primarily for one-way communication and do not include full speech-to-speech capabilities in the reverse direction. In cases where reverse translation is allowed, it is highly limited—for example, to 3 short phrases in the Phraselator system.
The systems treat the speech recognition and translation as separate, cascaded components, so they do not share the same grammars and the same domain limitations.
The systems are not easily user extensible because of both the complexity of the speech recognition grammars and the complexity of the underlying translation component. In order to add new words, phrases, translations, or syntactic forms, the systems must be updated by the original designers or by equivalent programmers possessing expert-level knowledge.
The systems are built for ephemeral communication, so do not provide logging and annotation capabilities for storing and reviewing the interactions.

All of these systems—both MT systems and phrase-book systems—use some underlying database to describe the inputs which are recognized and translated by the system. Machine Translation systems use grammars which combine to describe an essentially limitless range of inputs. Phrase-book systems use phrase lists, which might allow for minimal variations by filling in a blank in the phrase (such as “I want to go to the ______.”). However, these grammars and phrase lists feature a number of drawbacks.
Traditional Knowledge-Based Machine Translation (KBMT) approaches require hand-built grammars which are extremely complex and exceedingly costly to build, requiring much linguistic expertise in both the source and target languages.
Alternatively, Example-Based Machine Translation (EBMT) attempts to use a database of translation examples to perform translations. The database is searched for close matches to a new input sentence, and the appropriate translation is generated dynamically based on the database example. While this avoids much of the human effort of KBMT, EBMT has been limited in the complexity of the sentences it can translate. While exact matches with the database are trivial to locate, generalization of the database examples is difficult and inexact. For example, the phrases “shake a leg”, “shake a finger (at)”, and “shake your head” are all superficially similar, the translations will be very different.
Additionally, EBMT depends on syntactic similarity, so that a database sentence cannot be used as translation support for a semantically similar but syntactically divergent sentence. For example, even if the database contains the translation of “Can I take a train to Paris?” this cannot aid in the translation of the sentence “Is Bonn reachable by train?”
More recent Statistical Machine Translation (SMT) approaches attempt to remove the need for hand-constructed grammars by distilling a database of translation examples down to an automatically generated grammar. However, these approaches require very large databases of translation examples and the accuracy of these approaches is very low. The long-range utility of this approach has yet to be proven.
Basic phrasebook systems depend on hand-constructed phrase lists, which are time-consuming to construct and maintain.
And while phrase lists might be gathered through automatic means, the identification of words that can be replaced with blanks (such as in “I want to buy a ______.”) must be done by hand.

Due to the limitations of the prior art, it is therefore desirable to have novel methods of and devices for speech translation systems that overcomes the disadvantages of the prior art.

### SUMMARY OF INVENTION

The invention comprising a speech-to-speech translation device which allows one or more users to input a spoken utterance in one language, translates the utterance into one or more second languages, and outputs the translation in speech form. Additionally, the device allows for translation both directions, recognizing inputs in the one or more second languages and translating them back into the first language. The device recognizes and translates utterances in a limited domain as in a phrase book translation system, so the translation accuracy is essentially 100%. By limiting the domain the system increases the accuracy of the speech recognition component and thus the accuracy of the overall system. However unlike other phrase book systems, the device also allows wide variations and paraphrasing in the input, so that the user is much more likely to find the desired phrase from the stored list of phrases. The device paraphrases the input to a basic canonical form and performs the translation on that canonical form, ignoring the non-essential variations in the surface form of the input. The device can provide visual and/or auditory feedback to confirm the recognized input and makes the system usable for non-bilingual users with absolute confidence.

The device uses a single grammar database to perform both speech recognition and translation in a unified manner. By unifying the grammar databases, the system avoids the complication and redundancy of maintaining separate grammar databases for speech recognition and translation. Furthermore, the grammar databases serve to specify the domain of inputs that are recognized and translated, and this way the domain of both the speech recognition and translation can be constrained simultaneously and guaranteed to be equal in coverage. Furthermore, the grammar databases are readily plug and play such that one database can be removed from a first system and plugged into a second system such that the second system can immediately use the grammar database from the first system.

The grammars in the grammar database are easy to understand and simple to build and modify using only four abstract symbols to describe the phrases which are recognized and translated. The device includes a tool for the end user to build and modify the grammars used by the system, in order to dynamically improve the performance and coverage of the system. The grammars allow an arbitrary number of slots in the recognized phrases, and the device automatically detects and translates the contents of the slots and constructs the full output phrase, concatenating the various pieces according the ordering specified by numeric annotations on the grammars. For example, the device recognizes the input phrase “It is January eighth” and translates it as “Es el ocho de enero,” automatically constructing the full output phrase with slots filled and sections ordered correctly. The device also specifies an interface between the internal grammar database and the various grammar formats specific to each speech recognition engine, providing a generic platform onto which any speech recognition engine can be deployed.

The device is designed for two-way communication (and the design extends obviously to multi-way communication between more than two users), and includes speech recognition, translation, and speech output facilities for all language-pair directions. The device can include input and output devices to allow easy voice I/O for two or more users. This might include a device splitter attached to the USB port, headphone and microphone sockets, or other ports to allow multiple I/O devices to be used simultaneously. The splitter is controlled through three means: through mechanical means (such as a push button), through speech commands recognized by the speech recognition engine, and through signals sent from the computer. The device could also allow the user to choose input modes which indicate how the device monitors for inputs in each of the languages. The various modes allow for smooth operation and communication, depending on the type of conversations occurring. For example, in manual mode, the user explicitly indicates through a button or mouse event which language to expect for the following input. In toggle mode, the system automatically toggles between the languages, first expecting input in one language, and then input in the second language, and then back to the first.

The device also the ability to log all inputs, and allows for annotations of the dialogue with text, images, and sound files.

The device includes a mechanism for enabling the generation of grammars, either through manual or automatic means, which include empty slots that are filled with semantic restrictions. The tool allows a user to build a grammar by hand, or to follow a process for building grammars with slots and fillers in an efficient, simple manner. This grammar building process can be conducted entirely manually or steps can optionally be completed using automatic or semi-automatic tools. Examples of such tools are a program to divide sentences into meaningful semantic units, a program to group semantically similar phrases, and a program to suggest variations of a phrase which maintain the same meaning.

Accordingly, several objects and advantages of the invention are:
The system provides highly accurate translations and feedback which makes the system usable even for monolingual users.
The system can allow very flexible matching of variations and paraphrases of the stored phrases so that phrases in the system can be found easily, even with conversational speech input.
The grammars in the system can be used for speech recognition and translation simultaneously, making the processing more efficient and automatically applying the same domain restrictions on both levels of processing.
The grammars are easily modified by end-users using a grammar editing tool included in the device.
The grammars can allow arbitrary amounts of slots in the phrases with each part of the input translated separately and reordered to form the output translation according to ordering information in the grammar rule.
The device provides a uniform platform onto which any speech recognition can be deployed.
Two or more users can use the device to communicate simultaneously using I/O devices attached to the same USB port, headphone and microphone jacks, or other port.
The user can select the input mode which indicates how the device monitors for input in each of the input languages.
The system can log all input sound files, and can also allow for user annotation using text, images, or other sound files.

The system grammar database can be easily built and modified by the end user, including complex grammars involving slots and fillers and many phrasal variations.

### DESCRIPTION OF DRAWINGS

Further objects and advantages of our invention will become apparent from a consideration of the drawings and ensuing description.

FIG. 1a shows an overview of the speech-to-speech translation device.

FIG. 1b shows a preferred embodiment of the processing steps that a speech input follows as it is translated by the speech translation device.

FIG. 1c shows a simple example with a Semantic Tag that includes the grammar “(hi|hello) [there]”.

FIG. 1d illustrates Semantic Tags in two categories.

FIG. 1e shows examples of rules in both the universal format, and the format for the SRI speech recognition engine.

FIG. 2 shows a sample user interface for operation of the speech-to-speech translation device.

FIG. 3 illustrates an embodiment of a speech recognition engines within the speech-to-speech translation device.

FIG. 4 shows an embodiment of the Translation Synthesis component of the speech-to-speech translation device.

FIG. 5 shows an embodiment of the components of the Log Editor.

FIG. 6 shows a sample user interface for the Sound Annotator within the Log Editor.

FIG. 7 shows a sample user interface for the Text Annotator within the Log Editor.

FIG. 8 shows a sample user interface incorporating the Image Annotator for the Log Editor.

FIG. 9 shows a sample user interface for the Log Viewer and Post-Editing device.

FIG. 10 shows an embodiment of the components of the Semantic Tag Editor.

FIG. 11 shows a sample user interface for the Semantic Tag Editor.

FIG. 12a shows a sample user interface for the New Vocabulary Pronunciation Editor.

FIG. 12b illustrates a sample user interface for the construction of the grammars using a graphical tool included with the speech translation device.

FIG. 13 shows an embodiment of the multiple input-output devices attached through a single USB port, headphone/microphone jack set, or other port.

FIG. 14 shows an embodiment of the process flow of a sentence being matched against the speech recognition grammar and simultaneously translated.

FIG. 15 illustrates a rapid update process of the present invention.

### DETAILED DESCRIPTION OF THE PREFERRED EMBODIMENTS

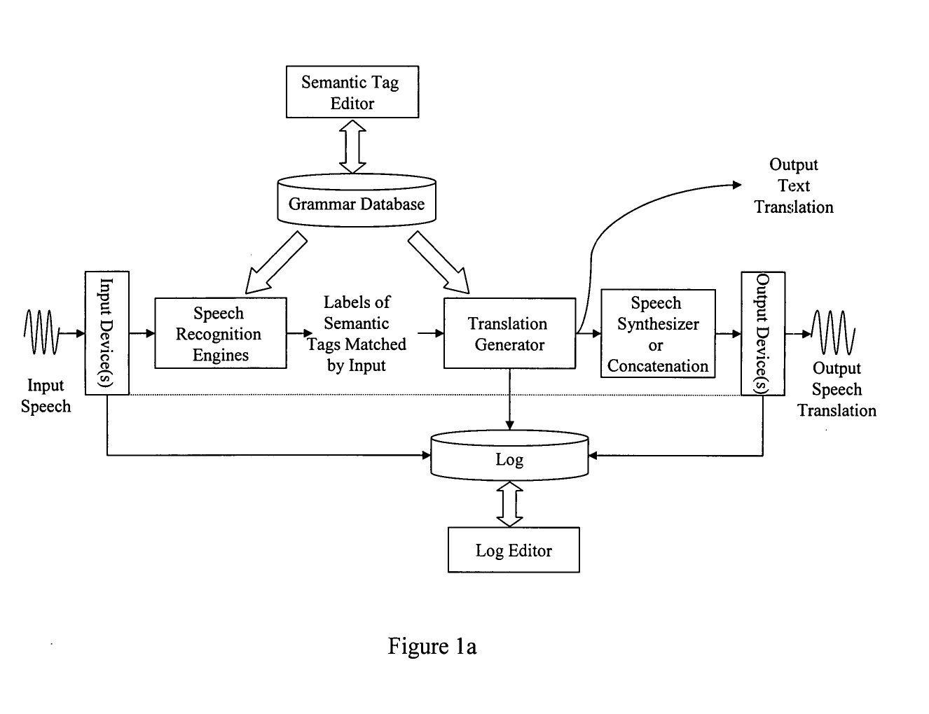

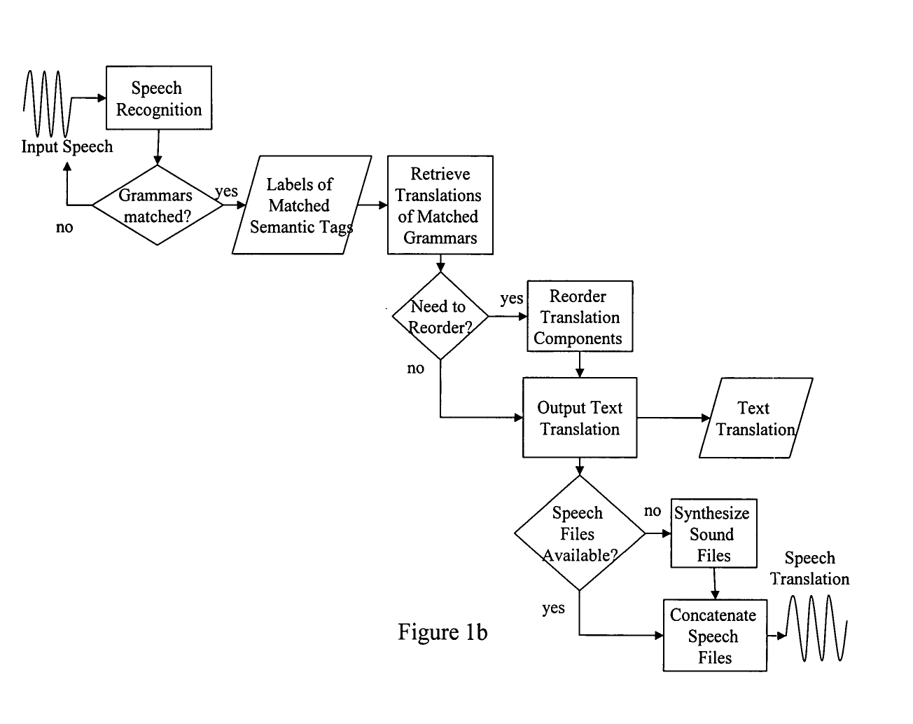

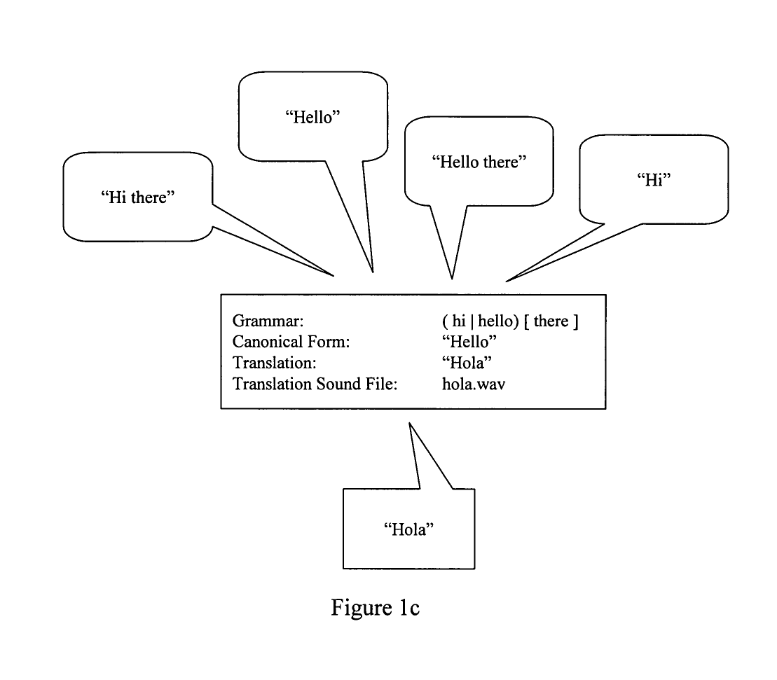

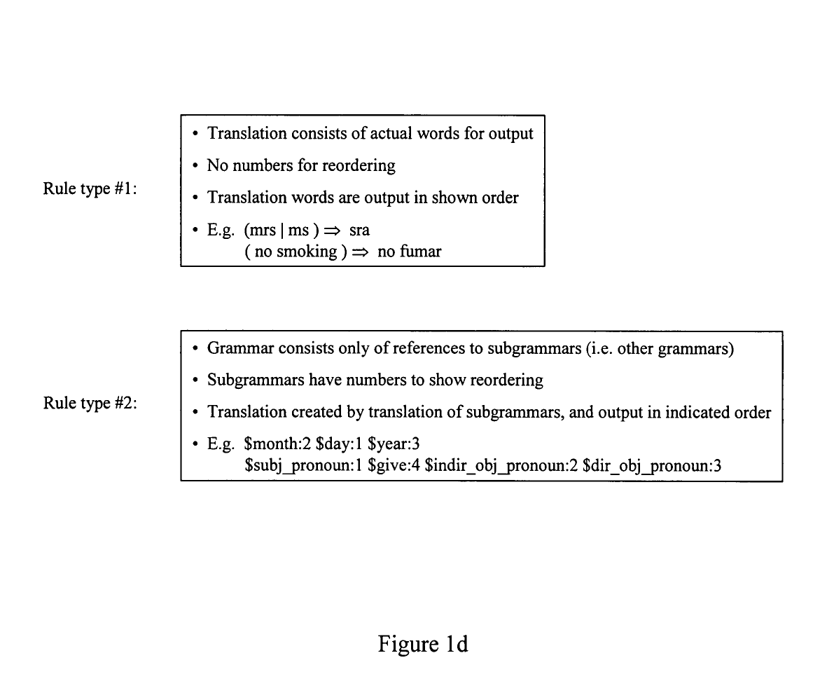

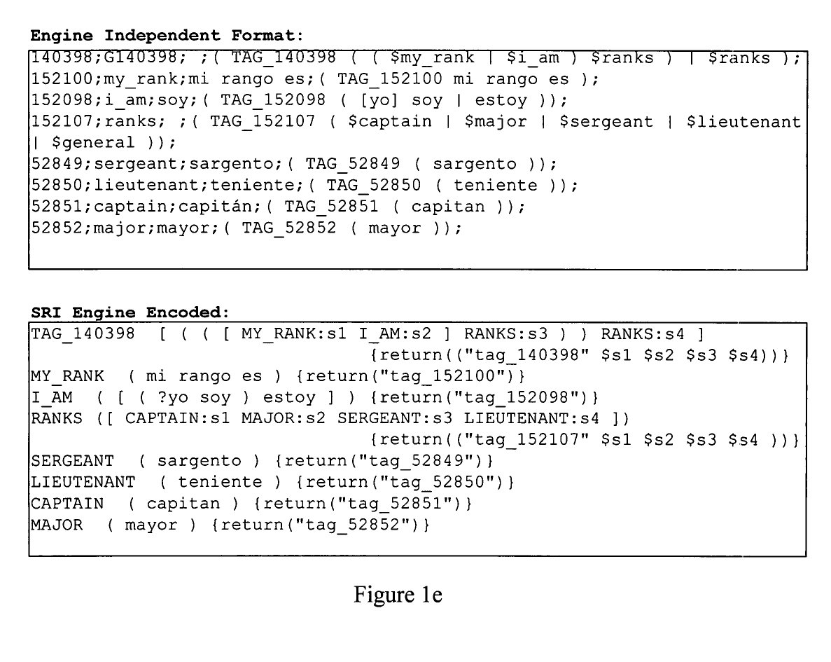

The various presently preferred embodiments are described below. Referring to FIG. 1a, the speech-to-speech translation device includes at the front end one or more input devices, which optionally includes one or two microphones each. In the case of multiple microphones, the microphones can be connected to the speech-to-speech translation device through a signal-splitting device connected to a single USB port, microphone jack, or other port. The signal-splitting device includes buttons to allow the user to control which microphone is live and which processing mode the translation device is operating in. The user guide of an embodiment of the present invention is attached herein as Attachment B.

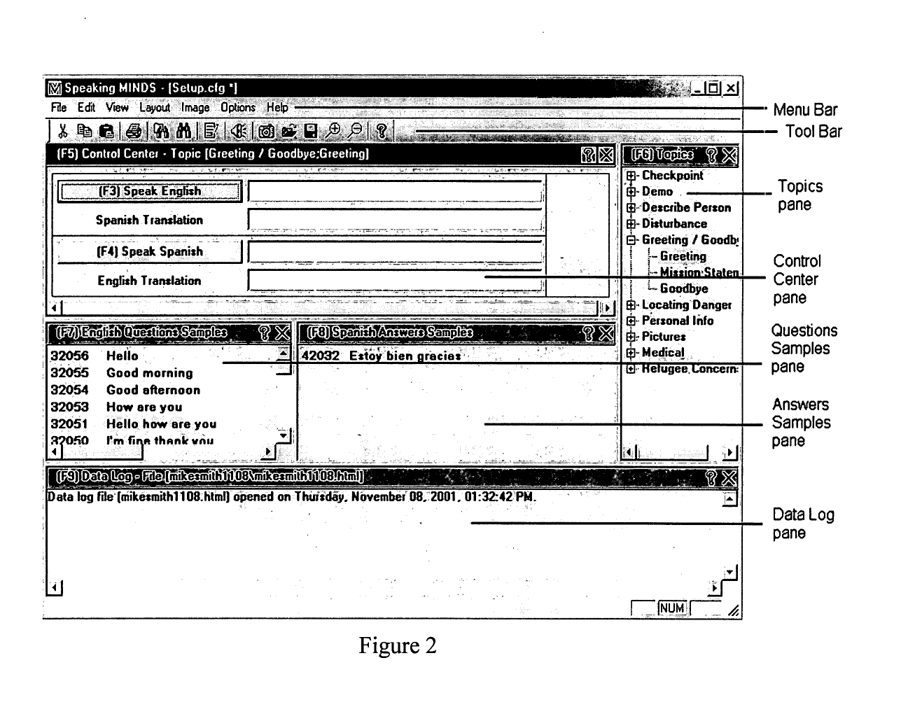

Referring to FIG. 2, also at the front end is a graphical interface which can display for the user the current domain, the phrases included in the currently active grammar, the responses included in the currently active grammar, visual feedback of the speech recognition and translation results, and the status of the log.

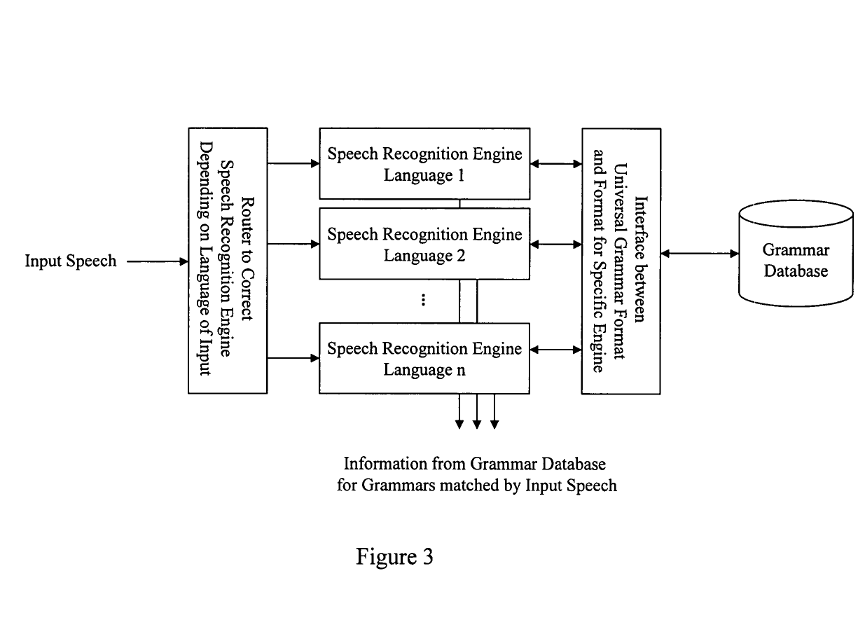

Referring to FIG. 3, the input device(s) are connected to one or many speech recognition engines through a router which determines which of the speech recognition engines will process the input signal. The possibly multiple speech recognition engines are connected to a grammar database through an interface which converts the universal format of the grammar database into the engine-specific format of the speech recognition engine.

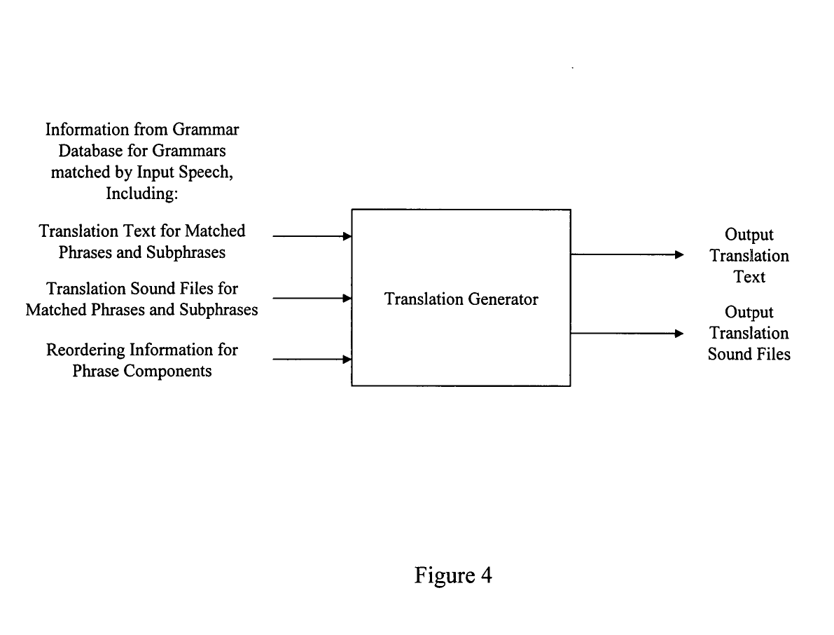

Referring to FIG. 4, the output of the speech recognition engines, comprising information returned from the grammar rules which were matched by the input speech signal, is connected to a translation synthesis component. The translation synthesis component accepts translation text for matched phrases and subphrases, translation sound files for matched phrases and subphrases, and information about the proper reordering of the phrase components, and outputs one or more translations in text and sound formats.

The translation synthesis component is connected at the output to a speech synthesizer for cases where the translation synthesis component could not produce a sound form of a translation. The translation synthesis component and the speech synthesizer are both connected at the output to an output device to transmit the sound form translation to a user. The output device includes optionally one or many speakers. In the case of multiple speakers, the speakers can be connected through a signal-splitting device to a single USB port, microphone jack, or other port. The signal-splitting device can route the output sound form translation to the appropriate speaker based on the speech recognition and translation results.

The translation synthesis output is also connected to a log where the sound and text form translation results are stored. The translation synthesis output may also connect to a graphical interface (FIG. 2).

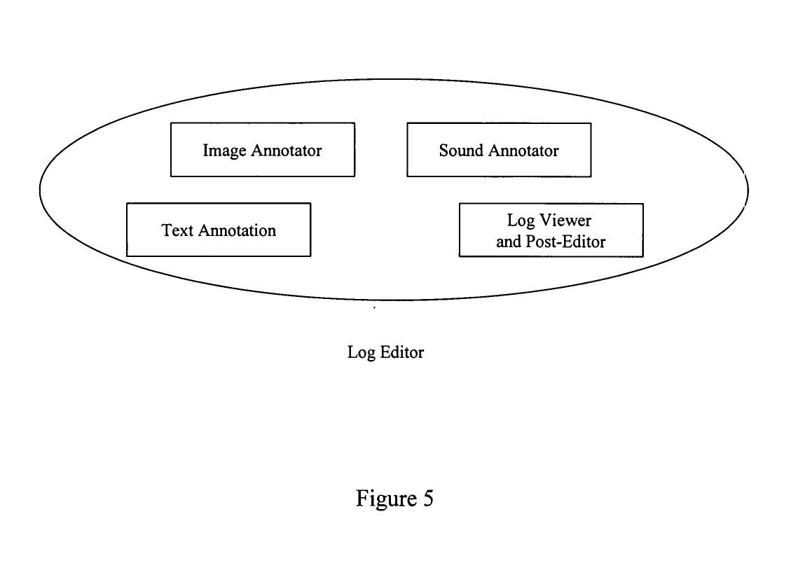

The speech-to-speech translation device can also include a log editor which allows user access to the log, referring to FIG. 5. The log editor includes a sound annotator for adding sound file annotation to the log, a text annotator for adding textual annotation to the log, an image annotator for adding images to the log, and a log viewer/post-editor for viewing and modifying the contents of the log.

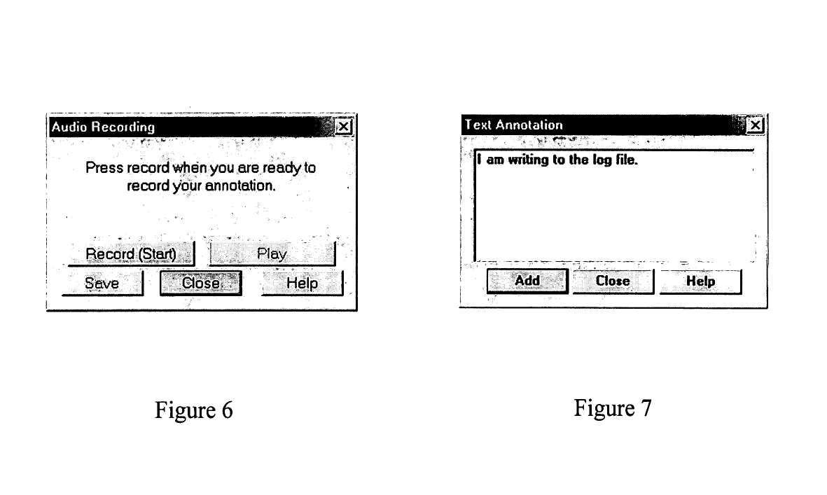

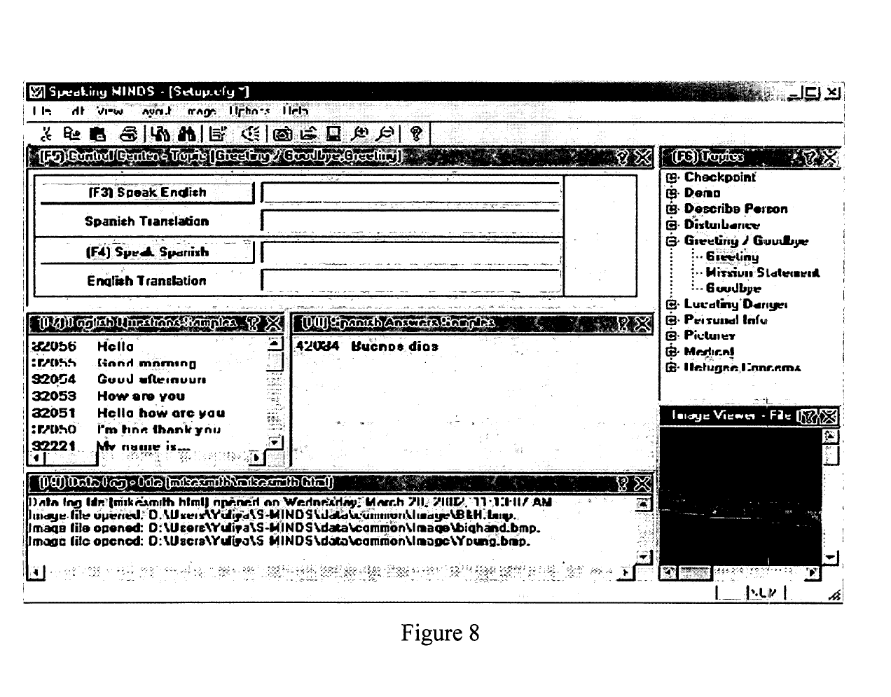

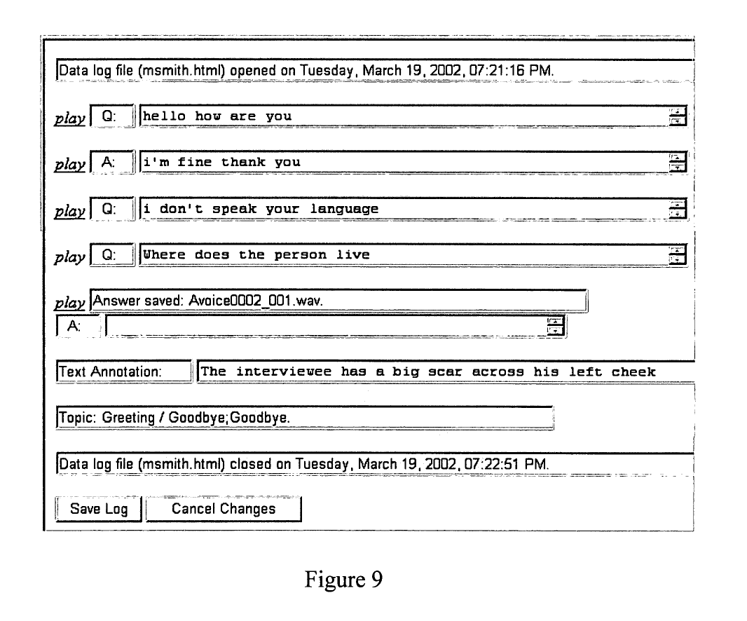

The sound annotator includes a graphical interface for interfacing with the user as illustrated by FIG. 6. The text annotator also includes a graphical interface for interfacing with the user (see FIG. 7). The image annotator includes a graphical interface incorporated into the speech-to-speech translation device's graphical interface for interfacing with the user (see FIG. 8). The log viewer/post-editor includes a graphical interface for interfacing with the user (see FIG. 9).

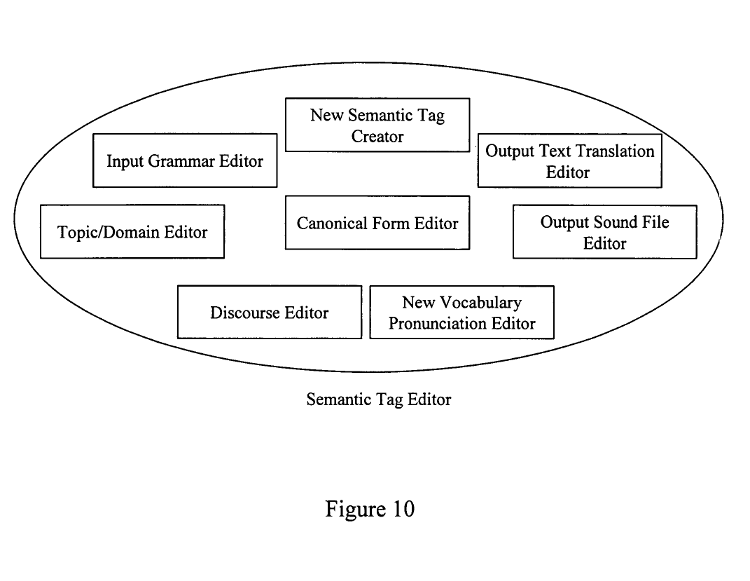

Referring to FIG. 10, the speech-to-speech translation device also includes a semantic tag editor which allows user access to the grammar database. The semantic tag editor comprises a new semantic tag creator for creating new semantic tags, an input grammar editor for editing the grammars of recognized input phrases, a topic/domain editor for editing the topical groupings of phrases within the grammar database, a discourse editor for editing the discourse restrictions between phrases in the grammar database (such as restrictions between questions and anticipated answers), a canonical form editor for editing the canonical form representation of the phrase, an output text translation editor for editing an output textual translations for a phrase, an output sound file editor for modifying an output sound translation for a phrase, and a new vocabulary pronunciation editor for adding pronunciation information for new words added to the grammar.

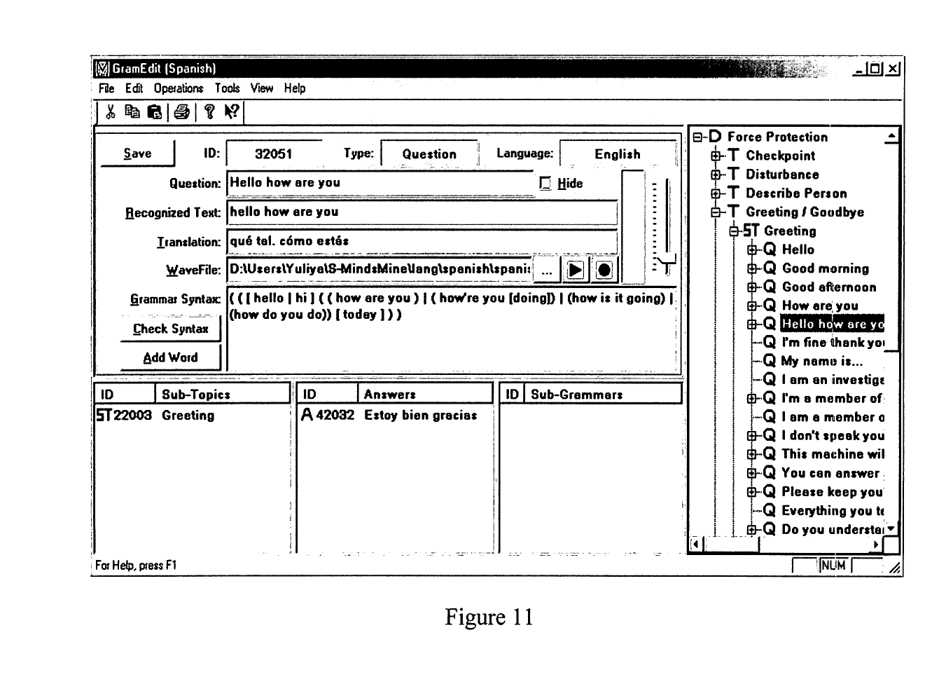

The semantic tag editor includes a graphical interface for interfacing with the user (see FIG. 11). The interface is connected to the input grammar editor, the topic/domain editor, the discourse editor, the output text translation editor, and the output sound file editor.

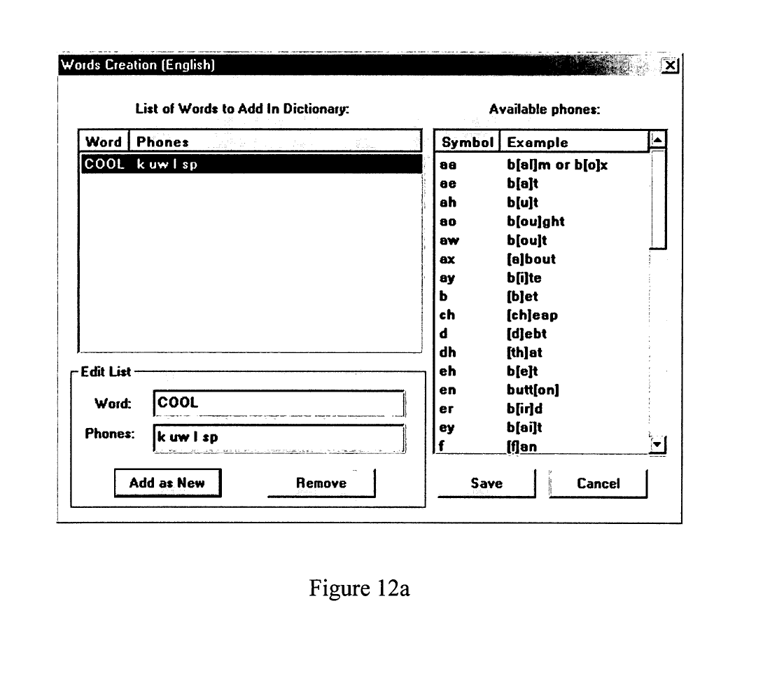

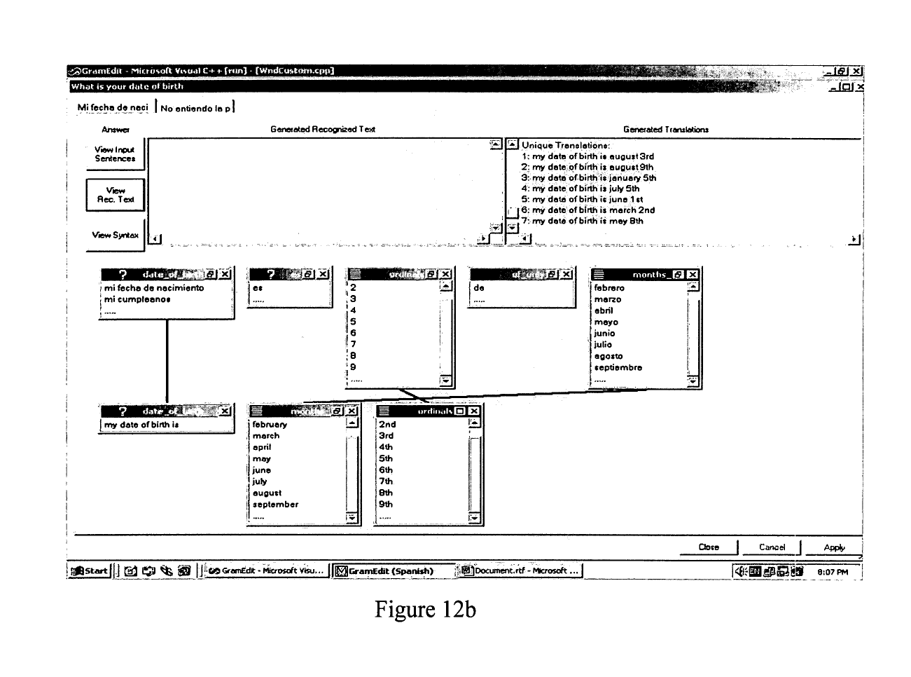

The new vocabulary pronunciation editor includes a graphical interface for interfacing with the user when a new vocabulary item has been entered in the input grammar editor (see FIG. 12a).

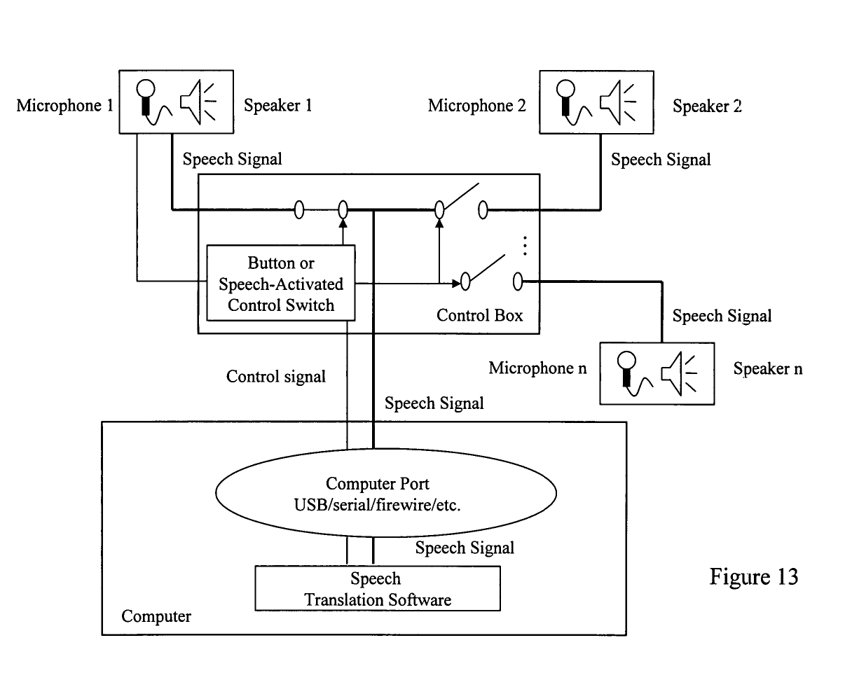

The input and output devices comprising of two or more pairs of microphones and speakers, and in one configuration these pairs are connected to a control box which can be connected to a computer through a USB port, a microphone/headphone jack pair, or another port (see FIG. 13). In another possible configuration the control box and one microphone/speaker pair are embedded in one box that is connected either through a wire or wirelessly to the computer. The other microphone/speaker pair is connected to the computer via the first device in this configuration. The control box contains I/O switches which allow one or more of the microphone/speaker pairs to be connected to the computer. The control box also contains a control switch which is optionally speech-activated. The control switch features a button which allows a user to choose which I/O switch is currently closed. The control switch is also connected to the computer through the USB port, microphone/headphone jack pair, or other port, and the speech translation software can send signals to the control switch to select which I/O switch is currently closed.

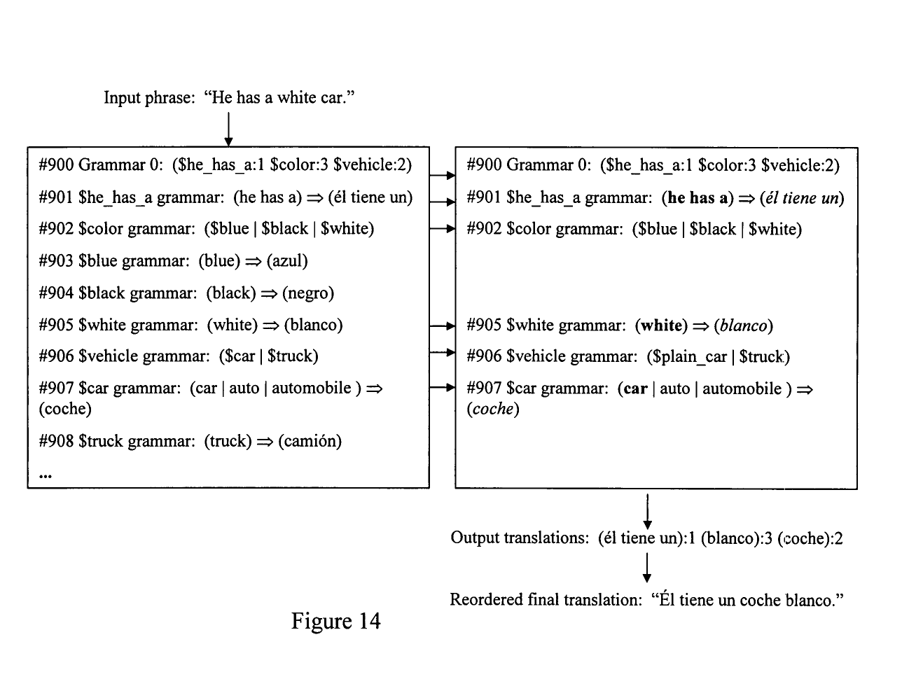

FIG. 14 displays the data path for an input utterance to be translated. The I/O device recognizes the input, which is then matched against the grammar rules. The matched rules are selected, and the output words are gathered. Finally the output words are reordered according to the reordering numbering on the appropriate grammar rules.

Overall Operation

The presently preferred embodiment of the present invention is a speech translation device designed to facilitate communication between two or more speakers who do not speak a common language.

FIG. 1a shows the overall architecture of the system. A user speaks into an input device which sends the input to a speech recognition engine. The speech recognition engine consults the grammar database to determine which of the grammars in the database are matched by the speech input. The indices of these matched grammars are then passed to the translation generator which again consults the grammar database, using the matched indices to extract the appropriate information to generate the output translation. The text translation and speech translation are output through an output device, which is usually joined with the input device. Throughout this process, the relevant information, including the input sound file and the canonical form of the recognized input or the translation of the recognized input, can be written to a log. The grammar database can be viewed and edited using a semantic tag editor, and the log can be viewed and edited through a log editor.

The Grammars

The heart of the system is the Grammar Database which is a collection of individual items known as semantic tags. Semantic tags are themselves records consisting of the following fields:
A grammar
A canonical text form
A translation in the second language (optional)
A sound file of the translation in the second language (optional)
Restrictions on the semantic tags which can be matched directly after the current semantic tag (optional)

A grammar is a token string which describes the class of phrases which trigger the semantic tags. In this way the entire semantic tag can be considered to be a conditional statement: If the grammar is matched by the speech input during the speech recognition phase, then the canonical text form, text and speech translations, and restrictions on subsequent semantic tags are applicable.

The grammar is written using three types of tokens: words in the source language, operators which can show variations such as optional or alternative words, and references to other grammars, known as subgrammars (herein written as a token string prepended with a dollar sign, such as “$color”). A word in a grammar is matched if and only if the word is identified in the speech input by the speech recognition engine. An operator is matched if and only if the variation that it represents is identified in the speech input by the speech recognition engine. For example, if brackets (“[” and “]”) indicate words that are optional, then the grammar “how are you [doing]” would match the two phrases “how are you” and “how are you doing” in the speech input. A subgrammar is matched when the grammar for the subgrammar is matched by the speech input by the speech recognition engine. For example, the grammar “$number $street_name” would be matched if and only if the grammars for $number and $street_name are matched in the speech input.

During the speech translation process, the speech recognition engine attempts to match the speech input against the currently active semantic tag grammars. The set of currently active semantic tags is affected by three factors. The anticipated language of the next input can limit the active semantic tags to those tags with grammars in the anticipated language. (The method for setting the language of the next input is described in the following section, “I/O Devices.”) The currently selected topic domain can limit the semantic tags to those which are included in that domain. (A topic domain is simply a collection of semantic tags.) If the previously matched semantic tag has restrictions that limit the semantic tags of the next speech input, then only those semantic tags allowed by the previous input are currently active. In another configuration, all of the grammars could be active at all times with no restrictions.

The speech recognition within the speech translation device is performed through third-party speech recognition engines which are licensed components of the device. Because different speech recognition engines might be better for different languages, the device allows speech recognition engines from multiple providers to be run at the same time in the speech translation system (see FIG. 3). In order for the simple substitution of engines from various sources, the speech translation device includes a uniform platform for deploying speech recognition engines with varying API's and varying grammar formats. The uniform platform provides a uniform API interface between the speech recognition engines and the rest of the speech translation device. The uniform platform also includes a mechanism for mapping grammars written in the universal grammar format of the system with the specific grammar format of each speech recognition engine. FIG. 1e shows examples of rules in both the universal format, and the format for the SRI speech recognition engine.

The device can also include a tool for creating and modifying semantic tags, called GramEdit. An user documentation for an embodiment of the GramEdit is present herein as Attachment A. This tool allows the following operations:
Construction of new semantic tags.
Creation or modification of grammars.
Creation or modification of canonical forms.
Creation or modification of text translations.
Creation or substitution of speech translation files.
Creation or modification of topic domains.
Addition of new vocabulary and new pronunciations.
Creation or modification of restrictions on immediately subsequent semantic tags.

The above creation and modification of semantic tags can be done through the form interfaces of the GramEdit tool (FIGS. 10, 11, and 12a). Additionally, the construction of the grammars can be performed using a graphical tool included with the speech translation device (FIG. 12b). The graphical tool is used as part of the following process flow for constructing grammars:
1. Data which needs to be recognized by the speech translation system is gathered. For example, for a travel reservation system, data from actual plane reservation phone calls could be gathered.
2. The sentences from the data are broken up into smaller semantic units. For example, the sentence “I want to go to New York from San Francisco” could be broken into the components “I want to go”, “to New York”, and “from San Francisco”. This process could be done manually or using a tool such as a chunk parser (or any automatic tool that breaks the sentences into smaller meaningful components) to divide up the sentences automatically.
3. The smaller semantic units can themselves be broken up further in a hierarchical fashion. For example, the phrase “to New York” in step 2 might be broken down into “to” and “New York”.
4. The smaller semantic units are grouped according to semantic similarity. In other words, synonymous units are grouped into equivalency classes. For example, one class might contain the phrases “I want to go”, “I need to get”, and “can you get me”. This grouping can either be done manually or through automatic means, such as using clustering techniques. In one configuration, one could also use latent semantic indexing for improving the clustering.
5. Other semantic units which are not synonyms but which behave similarly can also be grouped into categorical classes. For example, the phrases “blue”, “green”, and “white” might be gathered into a class representing the colors. This also can be done by a linguist or automatically by some kind of a clustering algorithm.
6. The equivalency classes and the categorical classes can be augmented with additional synonymous phrases which might not be present in the gathered data, but which the speech translation system should handle. These additional phrases might be added manually, or they might be gathered from a traditional thesaurus or even a phrase-based thesaurus.
7. Select translations for each phrase. This step differs depending on the composition of the phrase. For example:
   a. For phrases which have not been broken down into smaller semantic units (i.e. atomic phrases) and which have been grouped into synonymous equivalency classes, one can select a canonical form for each equivalency class, and then translate that canonical form into the desired target language. This translation might actually be null (or the empty string) if the target language doesn't require the phrase represented by the class.
   b. For atomic phrases which have been grouped into categorical classes, translations can be selected for each phrase within a generalized phrase class. So within the color class, “blue” would be translated to “azul”, “white” to “blanco”, etc.
   c. For phrases which have been broken down into smaller units (i.e. non-atomic phrases)—true for all words, phrases and phrase sequences—one can indicate how the translations of the smaller units must be reordered to form a correct phrase within the target language. For example, the phrase “cheap ticket” might be broken down into “cheap” and “ticket”, so we need to indicate that if translating into Spanish the translation of “ticket” must come first and the translation of “cheap” second. This is indicated by appending numbers to the components in the Grammar to show the reordering on the output side.
      Paraphrasing and Translation

FIG. 1b shows one embodiment of the processing path that a speech input follows as it is translated by the speech translation device. The Input Speech signal is fed to the speech recognition engine. If the input speech signal does not match any grammars successfully, then a suitable error message is generated and the computer waits for another input. If the input speech signal successfully matches one or many of the grammars, then the indices of the matched semantic tags for those grammars are returned.

In an alternative embodiment in grammar matching, a verification feature may be implemented to ensure the accuracy of the speech recognition. Here, the speech recognition engine generates a confidence value with respect to the input speech to indicate the probability of a match. The confidence value can be compared against a threshold value, where if the confidence value is greater than the threshold value, a match is declared. If the confidence value is lower than the threshold value, verification can be requested from the speaker by asking the speaker whether the translation is correct. For example, if the confidence value is lower than a threshold value, the system can ask the speaker “Did you say . . . ”.

The threshold value can be generated as a function of the complicity of the expected response. For example, if the expected response is a short phrase, the threshold value can be set requiring a higher confidence value. For example, if the expected response is a “yes” or “no” short answer, the threshold value can be set high requiring higher confidence value for such input speech. While, if the expect response is a long phrase, the threshold value can be set to a lower confidence value.

The indices are used to retrieve the translations of the matched grammars which begins the process of translation generation—generating the output text and speech. (see FIG. 4) If any of the matched grammars include reordering notations, then the components are reordered to produce the output text translation. If no reordering notations are found, then the output text translation can be returned directly. If speech files are available for the output text translations, then these can be returned to produce the output speech translation. If they are not available, then the output text translation can be sent to a speech synthesizer to generate the proper sound forms, producing the output speech translation. This sound form is returned as the speech translation.

FIG. 3 shows an illustration of the initial processing box, where the input speech is fed to the speech recognition engine. Here we see that the input is actually passed to a router which determines which of the possibly multiple speech recognition engines should receive the input, based on the language of the input. For example, Spanish input should be fed to the Spanish speech recognition engine. The router could either select the engine based on the anticipated language of the speech input, or it could perform automatic language identification and route the input accordingly. The selected engine queries the grammar database through an interface which translates the grammars in the universal format of the grammar database into the format specific to that engine. The speech recognition is performed using these grammars, and if any of the grammars are matched successfully, then the indices of the semantic tags associated with these grammars are returned.

As described in the previous section, each semantic tag has an associated grammar, which describes a set of phrases which, when matched, triggers that particular semantic tag for translation. The effect of this organization is that all of the phrases which match the grammar for a given semantic tag are considered to be semantically equivalent, or paraphrases of one another. While the phrases might obviously vary in certain small details, for the purposes of translation the phrases are treated equivalently. All of the variations are represented by the canonical form associated with the semantic tag, and the translation for the entire set of phrases is given by the translation associated with the semantic tag.

FIG. 1c shows a simple example with a semantic tag that includes the grammar “(hi|hello) [there]”. This grammar matches the phrases “hi”, “hello”, “hello there”, and “hi there” and all of them can be presented by the canonical form “Hello” which would be displayed if any of the phrases were recognized by the speech translation device. Additionally, the translation “Hola” would be returned as the translation for any of these phrases, and the sound file for the word “hola” would be returned as the speech translation of any of these phrases. The net effect of this organization is that the speech translation device first paraphrases the input into a canonical form, and then translates this canonical form. This allows the system to ignore small variations in the input which will not effect the output translation. In this specific example, the addition of the adverb “there” or the difference in formality between “hello” and “hi” are ignored, and “hola” is preferred as the translation for all of these phrases.

In the translation generation step, the indices of the semantic tags associated with the grammars matched by the speech recognition engine are used to retrieve the semantic tags from the grammar database. The structure of the semantic tags was described in the previous section, where it was noted that a semantic tag optionally has a translation associated with it. Semantic tags fall into two categories, as shown in FIG. 1d.
In the first type of semantic tag, there is an actual translation (i.e. a word sequence in the target language) associated with the semantic tag. In this case, the grammar associated with the semantic tag does not need to feature any reordering information, and the output translation is exactly as given in the translation.
   In the examples given, “mrs” or “ms” will both translate as “sra”, and “no smoking” translates as “no fumar”.
In the second type of semantic tag, there is no translation given. Instead, semantic tags of this type are required to have associated grammars which consist solely of references to subgrammars (i.e. grammars associated with other semantic tags). Attached to the subgrammars are numbers to show reordering information. Translation can be performed by translating each of the subgrammars, rearranging those translations according to the reordering information, and returning those reordered translations as the output translation.
   In the first example, we see a likely grammar for a date being translated into Spanish. Here the numbering shows that an English-language date such as “Apr. 1, 2004” should be produced with the day information first (“el 1”), the month information second (“de Avril”) and the year information last, producing “el 1 de Avril 2004”. Similarly, the second example shows that a double-accusative sentence such as “I gave you it” should be rendered into Spanish with the subject first (“yo”), indirect object second (“te”), direct object third (“lo”) and giving verb last, producing “Yo te lo di.”

FIG. 14 shows a detailed example of how the translation process works on the input “He has a white car” with the given grammars. Here, the speech recognition engine matches the grammars for the semantic tags #900, #901, #902, #905, #906, and #907 for the following reasons:
Grammar #900 is matched because the subgrammars #901, #902, and $906 are matched.
Subgrammar #901 is matched because the word sequence “he has a” is matched in the input.
Subgrammar #902 is matched because the subgrammar #905 is matched.
Subgrammar #905 is matched because the word sequence “white” is matched.
Subgrammar #906 is matched because the subgrammar #907 is matched.
Subgrammar #907 is matched because the word sequence “car” is matched.

To generate the output translation, the translation of each semantic tag is consulted. Semantic tags #900, #902, and #906 do not have translations, and instead have reordering information on the subgrammars in the grammar (which is suppressed when the output order is the same as the input order). Semantic tags #901, #905, and #907 have literal translation strings, though. So to translate semantic tag #900 we first translate the subgrammars, producing:
(él tiene un):1 (blanco):3 (coche):2

and then reorder them, producing the final translation:
“Él tiene un coche blanco.”
   The I/O Devices

The speech translation system enables communication between at least two speakers who do not speak a common language. Accordingly, the system features two or more sets of input and output (I/O) devices, each pair associated with one of the two or more input languages.

The system optionally includes a control box which allows the two or more sets of I/O devices to be connected to the computer through a single USB port, a single pair of headphone/microphones jacks, or other port. The I/O device pairs connect to the control box, which in turns connects to the computer through the single port. The I/O devices can be changed to whatever device is most convenient for the current application, and can include headsets with microphones, walkie-talkies, telephone handsets, or microphones and loudspeakers.

Within the control box there is a control switch that controls which of the I/O devices is currently active. During the operation of the speech translation device, the computer must be in a state expecting input in a certain language before it can accept a speech input. The current state of the speech translation program and the control switch must be coordinated to ensure that the I/O device for the proper language's speaker is the same as the expected language of the next input. Such coordination is enabled by communication passed back and forth between the computer and the control box.

Control can be set in one of three ways.
1. Mechanically. The control box can feature a set of buttons or switches which allow the user to indicate manually what the language of the next input will be. For example, there is a button or switch position which represents English, and so when the English button is pushed or the switch is put into the proper position for English, the computer will expect the next input to be in English.
2. Through spoken command. A command spoken into the currently active input device can be recognized by the speech recognition engine and will instruct the speech translation program what language to expect for the next input. The control switch will be set so that the appropriate I/O device will become active.
3. Through computer control. The speech translation device must operate in one of four modes which can indicate in what order the computer should expect inputs in each language. In certain modes, after input in a certain language is recognized, the computer immediately switches to expect input in a certain language, and the control switch is set appropriately to make the correct I/O device active. Additionally, as discussed in the previous section on grammars and semantic tags, some semantic tags include restrictions on the semantic tags which can be recognized immediately subsequent to the given tag. These restrictions can be used to set the expected language of the next input, and the computer will set the control switch appropriately.

As mentioned in point #3, the computer can operate in one of four modes; the current mode is selected by the user. The modes are as follows:
1. Manual mode. In this mode, the language of the next input is always set explicitly by the user, either through mechanical means (as through a button or switch) or through a voice command.
2. Toggle mode. This mode is especially appropriate when the system is being used in a question/answer setting, with the first-language speaker asking questions of the second-language speaker. In this mode, after an input in the first language is recognized, the system immediately expects input in the second language.
3. Repeat mode. This mode is similar to Toggle mode, except in this mode after the system switches to expect an input in the second language, then as long as the system fails to recognize an input in the second language the system will continue to expect an input in that language.
4. Continuous mode. Again, this is similar to Toggle mode, except after an input is recognized in the second language the system immediately switches to expect input in the first language again, and so on, continuously switching back and forth between expecting inputs in each of the two languages.
5. Voice activated mode. In this mode the computer turns on automatically when either person speaks. This could be simply voice activated or with the prompting of a particular word by the user. In the case of the 2^{nd} language speaker, this may include giving the 2^{nd} speaker the ability to talk over the system prompt if he or she wants to start the answer before the question is finished playing.
   The Log

During the operation of the speech translation device, a user has the option of turning on the logging functionality. This records all interactions during the current session to a new or existing log. The log includes the actual sound files of the inputs to the speech translation device, the textual translations, as well as any annotations included during the course of the session. These annotations can take the form of textual notes, sound files, or images.

A log editor can be included with the speech translation device (see FIG. 5), which provides the tool through which the user annotates the log during the session, views the log, and edits the log after the session is concluded. The log editor includes a sound annotator, which allows the user to record a sound file which is added to the log (FIG. 6). The log editor can also include a text annotator which allows the user to make textual notes which are added to the log file (FIG. 7). Additionally, the log editor can include an image annotator (shown in the lower right window of FIG. 8). This allows the user to open an image during a session and have the image saved to the log. The user can also draw on the image using an included drawing facility. The drawn annotations are included on the image saved to the file.

Another feature of the log editor is the log viewer, which is an interface which allows easy access to the sound files and text translations of the session, as well as any text, sound, or image annotations (see FIG. 9). The log is saved in HTML format, so the log viewer can be a simple web browser. The log is saved in a format which is the most useful and easiest to use for a monolingual user. In this format, one language is chosen as the primary language, and all of the interactions are shown in this language. So, for example, if the display language is English, then all English inputs are shown as they were recognized (actually, the canonical form of the recognized phrase is shown) and all inputs in the second language have their English translations displayed. This makes the entire log readable in the display language, easy to use for monolingual speakers of that language.

### SUMMARY

Thus, the speech-to-speech translation device described above provides extremely accurate translation within a domain, allowing even monolingual users to use automatic translation confidently. The device gains this high accuracy through limiting the domain of recognition to phrases indicated in the grammar, however the highly flexible nature of the grammar allows the system to recognize a very wide range of variations and paraphrases, producing a system which is much easier to use and much more forgiving of linguistic differences between users. The device employs a single grammar for both the speech recognition and translation, creating a less complex system which ensures that coverage of the speech recognition and translation components are identical and no unnecessary processing is performed. Furthermore, the simple grammar format is easily modified and personalized by the end-user creating a flexible, more powerful system that is quickly updated to whatever specific user needs are encountered. In spite of the simplicity of the grammar, the grammar allows arbitrary numbers of slots in the recognized phrases, so each grammar rule can recognize and translate not just an atomic phrase, but whole classes of phrases, producing a much more powerful translation device. The generic grammar format also allows easy deployment of any speech recognition engine within the speech-to-speech translation device so that the best engine for each input language can be used, creating a best-of-breed speech-to-speech translation solution. The translation device also allows much more natural conversation between two or more interacting users by including I/O devices which allow multiple microphones and speakers to be connected through a single USB port, single set of microphone and speakers jacks, or other port. The device further accommodates natural interactions by allowing the user to specify one of many input modes, depending on the type of conversational interaction that is being translated. The device also logs all interactions to allow users to review the actual sound inputs and translations from a conversation, and also allows annotation of the conversational log with text, sound, and images. The log is conveniently viewed and post-edited through a graphical interface, allowing the user to benefit from the translations long after the translated conversation has ended. The device includes a device to automatically generate complex grammar rules from a training corpus, in which the rules allow for semantically-restricted empty slots.

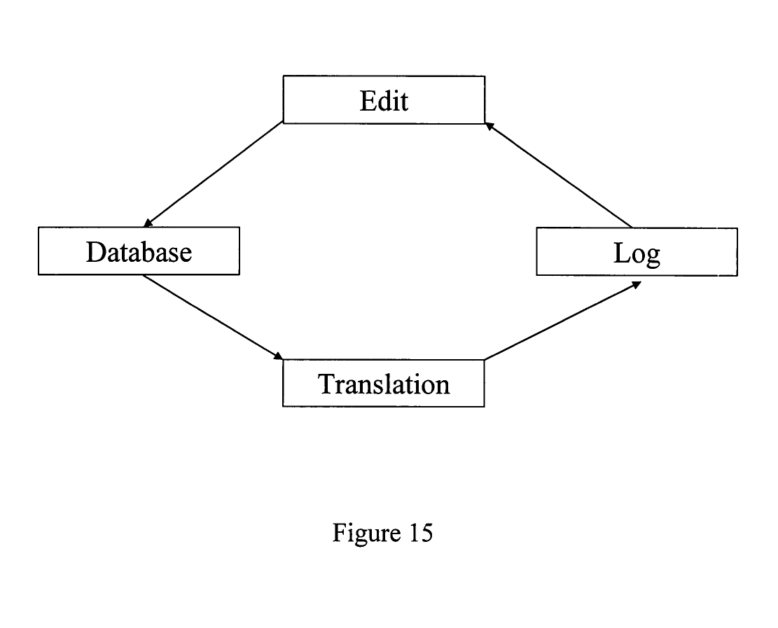

In yet another alternative embodiment, a rapid update feature can be implemented with the use of the log. Referring to FIG. 15, since all translations performed are logged, the log itself becomes a source for updating the grammar database. The log can be quickly edited either manually or automatically, and be added to the grammar database. The grammar database now updated can be immediately used for translation. This entire process can be performed in real time.

While the preceding description contains many specificities, these should not be construed as limitations on the scope of the invention, but rather as an exemplification of one preferred embodiment thereof. Many other variations are possible, including:
A device which translates between more than two users, with additional input and output devices as necessary to accommodate additional simultaneous users;
A device which translates between more than two languages, with additional Speech Recognition engines as necessary to accommodate the additional languages;
A device which provides control and feedback through auditory means, eliminating need for the graphical interface;
A device which provides I/O through non-auditory means, such as allowing typed input, mouse-clicks to select inputs, and output to a screen;
A device which lacks one or many of the logging features in order to conserve memory requirements;
A device which translates communication between users who are physically separated, inserting communication over a network or wireless device at one or many stages of the processing;
A device in which one or many of the components are deployed in client-server format, servicing multiple speech-to-speech translation devices at once.
   Attachment A
   GRAMEDIT A Graphical Tool for Building New Translation Domains—User Documentation Version 1.5.0
   1. Introduction

This document contains the documentation for GramEdit, a graphical tool that comes with the speech-to-speech translation system Speaking MINDS (S-MINDS). This tool enables a user of S-MINDS to easily and rapidly add new domains in any language or to modify existing translation domains.

This document is organized in the following manner.
Section 2. Overview of GramEdit describes some basic terminology and concepts of speech recognition that must be understood in order to use GramEdit effectively.
Section 3. The Wizard describes how to use the wizard to add or edit questions and answers.
Section 4. Session Management is all about session management.
Section 5. Advanced Stuff reviews advanced features that are not yet part of GramEdit but will be added in the near future.

NOTE: The current version of this document will only describe how to use GramEdit with the help of a wizard that guides the user through each step. Future versions of this document will describe how to use the tool without the wizard.

2. Overview of GramEdit

Using GramEdit requires understanding of some basic concepts of speech recognition and translation. Below you will find a brief overview of these concepts.

2.A. Functional Overview of S-MINDS and GramEdit

Unconstrained speech-to-speech translation is currently an unsolved problem. Therefore, S-MINDS takes the approach of providing automatic translation only for a very specific domain. However, in addition to being domain-specific, S-MINDS is also designed so that new domains and languages can be added easily and quickly.

The basic functionality of S-MINDS is this: All material pertinent to a particular domain is organized in a tree hierarchy that maps the flow of a possible conversation. For each part of the conversation, there are sample sentences. For each sample sentence, there is a translation. Also, for each sample sentence, a recognition grammar is needed. This grammar defines many of the different ways of saying a sentence with the same meaning as the sample sentence. If the user speaks one of the sentences as defined by the grammar, the system will recognize what the user has said. Following this, S-MINDS locates the corresponding sample sentence and its translation. This translation is then played aloud so that the second user of the system can hear the translation of what the first user said and respond in his or her own language. If S-MINDS is used in the two-way translation mode, the system will again have a grammar to cover all possible answers in the target language. The translation back to the source language is then executed in the same manner as the source to target language translation. If S-MINDS is operating in one-way translation mode, the response of the second user will be recorded for future manual translation.

All the sample sentences, grammars and recordings of sample sentences for a specific domain need to be provided to S-MINDS by a human expert. GramEdit is the tool that makes this task fast and easy.

Adding a new domain consists of the following steps.
Adding sample questions and their answers for this domain by using the wizard.
Arranging all added questions and answers in a hierarchy that maps the conversation flow.
Creating a grammar needs for each question and answer to cover the variety of ways of asking the question.
Recording a translation for each question.

How to execute these steps is described in detail in Section 3.

2.B. Speech Recognition Concepts

As described above, adding a new domain to S-MINDS involves adding grammars for each sample sentence. This section will explain the concepts of grammar, sub-grammar and pronunciation dictionaries.

Grammar: Generally speaking, speech recognition works by finding the most likely sequence of words within a possible set of word sequences. Different people have different words and ways of expressing the same meaning, and there are usually many different ways of saying the same thing. For example, the question, “When did you leave from there?” could just as well be phrased as, “When did you leave that place?”. A recognition grammar defines the set of sentences that can be recognized. The syntax of such a recognition grammar is defined by the following rules.
( ) Everything within the round brackets has to be said in sequence. Example: (how are you).
   | Denotes alternatives. Example: (hello|hi|good morning)
[ ] Encloses optional words. Example: (how are you [today])

In the case of the two example answers above, the grammar would look like this:
when did you leave ([from] there)|(that place)

Sub-Grammar: A sub-grammar is a grammar that can be used within a grammar just like a building block. A sub-grammar is denoted by a “$” symbol. The syntax of defining a sub-grammar has the following format.
$sub_grammar_name=grammar definitions

In our example, we could create a sub-grammar called “location”.
$location=([from] there)|(that place)

It is then used in the main grammar:
(when did you leave $location)

Dictionaries and Pronunciation: Each word that is part of a grammar needs to be in a dictionary that will contain a description of how the word is pronounced. To understand the concept of the pronunciation, think of a foreign language dictionary. If you look up a word in this dictionary, there will also be a sequence of phonetic symbols that tell you how the word is pronounced in addition to what this word means.

NOTE: In the current edition of GramEdit, it is necessary to ensure that each word has an entry in the dictionary before using it in a grammar or sub-grammar.

2.C. Layout of the Main Screen of GramEdit

FIG. 11 shows a screenshot of the main screen of GramEdit. The following paragraphs provide a detailed description of each section and item in this window. The main window is divided into the following three sections.
a) Sentence definition, translation and grammar
b) Tree hierarchy of topics, subtopics, questions and answers
c) Detailed description of currently selected topic, subtopic, question or answer

a) Sentence Definition, Translation and Grammar

The top line of this window contains the fields ID, Type and Language. Every topic, subtopic, question and answer is automatically assigned a new ID when it is created. For example, the ID shown in the screenshot is the ID of the currently selected question. The Type field can have one of four values: Topic, Subtopic, Question and Answer. The Language field displays the currently used source language. For example, for English-to-Spanish translation, English is the source language and Spanish the target language. When component of type Question is highlighted, the Language field is set to English. When component of type Answer is highlighted, the Language field is set to Spanish. The Question field on the FIG. 2 displays a Sample Sentence of the currently selected phrase. Usually, there are several ways of asking a particular question, but the meaning of all variations is the same. Therefore, a sample sentence for a variety of sentences is chosen to represent the group of sentences. The field Recognized Text contains the text that will be displayed when any of the variations of a phrase are recognized. With this approach, it is sufficient to only translate the recognized text rather than translating every sentence variation. This translation is shown in the Translation field. The Sample Sentence is composed of its recognized text concatenated with the recognized texts of all sub-grammars specified in the Grammar Syntax field.

The variations of the sample sentence can be encoded or represented by a recognition grammar for each sample sentence. This grammar is displayed in the “Grammar Syntax” field. The button “Check Syntax” performs a syntax check on the grammar. New grammar or changes to a grammar cannot be saved unless the syntax is correct.

As the name implies, the Wavefile contains the file path for the wavefile that contains a recording of the translation for current sample sentence.

b) Tree Hierarchy of Topics, Subtopics, Questions and Answers

S-MINDS provides limited-domain, one-way or two-way translation. All material that belongs to a domain is organized in a hierarchical tree structure that maps the flow of a possible translation session. This tree hierarchy is shown in the section on the right side of GramEdit's main window (see FIG. 2).

The structure of the tree hierarchy is:

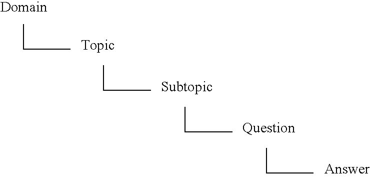

The first four levels of this tree will always be displayed in the source language. The answer, however, will be displayed in the target language. If the target language has a script other than the Roman alphabet, the answer will be displayed in the script of that language.

The meaning of each level in this hierarchy is explained below.
Domain: A domain represents the top level of a hierarchy and contains one or more topics and subtopics.
Topic: A topic contains all of the questions and answers for one interaction topic; for example, screening of a refugee or recording the personal data of a person.
Subtopic: A topic can be organized into several subtopics. This helps to organize and structure the content of a session. If a session consists of several steps that will be asked sequentially, organizing the steps into subtopics will help to define the flow of the session. For example, the Personal Info topic can be arranged into these subtopics.
   Greeting
   Personal Info and ID
   Travel and Destination
   Goodbye
Question: A question consists of a sample sentence, a grammar and a translation.
Answer: For two-way translation, each question requires an answer in the target language. The answer then consists of a sample sentence, grammar and translation back into the source language. In other words, the structure of an answer is just like the structure of a question.

In the default setup of the main window, the rightmost part of the screen contains a tree hierarchy of all the topics, subtopics, questions and answers. This tree can be expanded or collapsed in the same way as a typical file or directory hierarchy.

c) Hierarchy Details

The three-column-section below the sentence definition window contains the information about the parents and children of the currently selected topic, subtopic, question or answer. For each selected item, the “parent” and the “child” in the hierarchy are displayed. The right column displays parents of the selected item. The middle column displays children of the selected item. The right column shows sub-grammars that are used in the Grammar Syntax field of the selected item. For example, if a subtopic is selected, the leftmost part of the section displays the topic name and its ID number within which this subtopic is arranged. The middle part of this section displays all of the questions that are arranged under this subtopic, again together with their IDs. The rightmost part will show the sub-grammars used in the Grammar Syntax field of the selected item.

3. The Wizard

3.A. Wizard Overview

The wizard takes you through an easy, step-by-step process of adding new, deleting, or changing the existing grammars. You can also specify new sub-grammars as well as edit existing ones. Every window of the wizard has a “Next,” “Back,” and “Cancel” button to help navigate. If the window is completed successfully, the “Next” button takes you to the next step of the wizard. If there is an error or a need to return to the previous window, the “Back” button takes you back. If you wish to stop at any time, just press the “Cancel” button and the wizard exits.

At the end of each logical function in the wizard, there is a shortcut window called “Choices” that gives you four radio button choices.
The first choice is to repeat the exact task you were doing. For example, if you were adding a question, the first choice is “Add another question.”
The second choice is to repeat the operation you were doing, such as add, edit, etc. In our example, the second choice would be “Add some thing else.”
The third radio button is to “Perform another operation,” which takes you to the “Operation” window.
The forth choice is to “Change the answer language,” which takes you to the very first “Languages” window. So to restart the wizard, choose the last radio button of the “Choices” window.

After all the changes are made, it is very important to save and compile by choosing “File→Save” from the Menu bar.

3.B. Adding a New Grammar Using the Wizard

The grammar-editing wizard will appear at start up of GramEdit. If it is not present, you can open it by selecting the “Tools→Open Wizard” menu option. When following the steps in sections a) through e) below, start by selecting “Tools→Open Wizard.”

a) Add a New Question

Step 1: “Languages”—displays a drop-down list of available Answer languages. Select the language your answers are in even if you are only going to edit English. When finished, press the “Next” button.

Step 2: “Operation”—displays all of the operations that can be performed through the wizard. Select the “Add” radio button and then press the “Next” button.

Step 3: “Type”—displays the type of information that can be added. Select the “Question (English)” radio button and then press the “Next” button.

Step 4: “Parent”—add your question. Clicking on the topic or its associated [+] expands the topics tree to show subtopics. The valid subtopics to select are entries in the tree that do not have [+] or [−] next to their name, e.g., click on [+] for “Greeting/Goodbye” and then select “Greeting.” When finished, press the “Next” button.

Step 5: “Grammar”—this is the main grammar-editing window. The “Sample Sentence” field is grayed out because the sample sentence is being generated automatically based on the recognized text of the question and the recognized text of the sub-grammars used in this question.

Example: “What's Up”

In the “Recognized Text” field, type the text that you want to be displayed when the question is recognized; e.g., “what's up”.
In the “Grammar Syntax” field, type the grammar for recognition of the sentence. The parenthesis matching will indicate whether you are missing a bracket or parenthesis. If there is an unmatched parenthesis, the syntax text will be red. When parentheses match, the syntax text becomes green; e.g., “[(hey man)] what's up”.
After you have entered the syntax into the “Grammar Syntax” field, press the “Check Syntax” button, and the “Generated Sentences” dialog window will appear listing the sentence(s) created from the Grammar Syntax. If the sentence(s) created from the Grammar Syntax are correct, close the “Generated Sentence” dialog window by pressing the “Close” button. If the sentence(s) created from the Grammar Syntax are not correct, close the Generated Sentences dialog window, modify the “Grammar Syntax” field, and repeat the process of checking the syntax starting with pressing the “Check Syntax” button.
If the message box “GramEdit” appears telling you about words missing from the dictionary, refer to section 3.B.c., “Add a New Sub-Grammar,” “Step 4: Grammar,” for explanations.
In the “Translation” text field, type the sentence your question will be translated to, e.g., “que pasa”

When finished, press the “Next” button.

Step 6: “Wavefile”—lets you select the audio file that corresponds to the text translation that was entered on the previous window. You can either select an existing wavefile or record a new one.

To select an existing file, click on the browse button to browse. The “Open” dialog window will appear with the list of existing wavefiles. Select the file you need and click “Open.” The “Wavefile” text field should be filled with the path to the chosen file. You can listen to the file by pressing play button. NOTE: if you cannot hear your recording when pressing Play button, make sure that your system preferred audio device is set to devices other then USB Audio Device, and your microphone is plugged directly into your computer. To make sure your preferred audio device is selected accordingly, do the following: a) from Start menu choose “Settings→Control Panel→Sounds and Multimedia Properties, choose the “Audio” tab; b) in the Sound Playback and Sound Recording partitions, locate the Preferred Device: selection; and c) choose other then USB Audio Device.
To record a new wavefile, press the Record button. The button will change to the Stop button. When finished recording, press Stop button to stop recording. The “Wavefile” text field should be filled with the temporary path to your file and the temporary file name. You can listen to the file by pressing. NOTE: When the system accepts your changes, it will make a copy of the wave file you entered and rename it. The new name will be the same as the grammar ID and will look something like 130437.wav. When finished, press the “Next” button.
If the sample sentence generated by the system already exists in the system, the error window will appear saying that the sample sentence must be unique. Press the “Back” button to return to the “Grammar” window and correct the recognized text or the grammar field. The system may already have the same question, so try to find a similar question in the system and modify it to accommodate your differences.
Step 7: “Choice”—allows you to skip some steps when you are doing repetitive tasks. We are finished with this example, so just press the “Close” button.

b) Add a New Answer

Step 1: “Languages”—displays a drop-down list of available Answer languages. Select the language your answers are in even if you are only going to edit English. When finished, press the “Next” button.

Step 2: “Operation”—displays all of the operations that can be performed through the wizard. Select the “Add” radio button and then press the “Next” button.

Step 3: “Type”—displays the type of information that can be added. Select the “Answer (Language)” radio button and then press the “Next” button.

Step 4: “Parent”—displays a hierarchy of topics, subtopics and questions. Navigate to the question you want to add an answer to. Clicking on an entry or its associated [+] expands an entry. E.g., click on [+] for “Greeting/Goodbye” and then on [+] for “Greeting.” Then select “What's up.” When finished, press the “Next” button.

Step 5: “Grammar”—the “Sample Sentence” field is grayed out because the sample sentence is being generated automatically based on the recognized text of the answer and the recognized text of the sub-grammars used in this answer.

Example, “bien gracias” [Spanish]

Type the answer in the “Recognized Text” field.
In the “Grammar Syntax” field, type the grammar for recognition of this sentence. The parenthesis matching will show if you are missing a bracket or parenthesis. If there is an unmatched parenthesis, the syntax text will be colored in red. When parentheses match, the syntax text becomes green. Example, “[muy] bien gracias”.
After you have entered the syntax into the “Grammar Syntax” field, press the “Check Syntax” button, and the “Generated Sentences” dialog window will appear listing the sentence(s) created from the input in “Grammar Syntax.” If the sentence(s) created from the “Grammar Syntax” field are correct, close the “Generated Sentence” dialog window by pressing the “Close” button. If the sentence(s) created from the “Grammar Syntax” field are not correct, close the “Generated Sentences” dialog window, modify the “Grammar Syntax” field, and repeat the process of checking the syntax starting with pressing the “Check Syntax” button.
If the message box “GramEdit” appears, telling you about words missing from the dictionary, refer to section 3.B.c., “Add a New Sub-Grammar,” “Step 4: Grammar,” for details.
In the “Translation” text field, type the sentence that your answer will be translated to in English, e.g., “I'm fine, thanks.”
Press “Next,” and “Wavefile” window will appear.
   Step 6 “Wavefile”—follow the directions described in the Step 6: “Wavefile” for “Add a New Question.” The Wavefile text field must contain the path to your file before you press the “Next” button.
   Step 7: “Choice”—allows you to skip some steps when you are doing repetitive tasks. We are finished with this example, so just press the “Close” button.

c) Add a New Sub-Grammar

Step 1: “Languages”—displays a drop-down list of available Answer languages. Select the language your answers are in even if you are only going to edit English. When finished, press the “Next” button.

Step 2: “Operation”—displays all of the operations that can be performed through the wizard. Select the “Add” radio button and then press the “Next” button.

Step 3: “Type”—displays the type of information that can be added. Select the “Sub-Grammar ([Language])” radio button and then press the “Next” button. Step 4: “Grammar”—type the name of your sub-grammar in the “Sub-Gram Name” text field in [Language]. No spaces are allowed; use “_” (underscore) instead.

Example, “hi_reply” [English]
In the “Recognized Text” field, type the phrase that will be displayed as a result of the recognition with this sub-grammar, e.g., “good thanks”.
In the “Grammar Syntax” field, type the grammar body. The parenthesis matching will show if you are missing a bracket or parenthesis. If there is an unmatched parenthesis, the syntax text will be red. When parentheses match, the syntax text becomes green, e.g., “(good|cool|fine|well) [thanks]”.
After you have entered the syntax into the “Grammar Syntax” field, press the “Check Syntax” button, and the “Generated Sentences” dialog window will appear listing the sentence(s) created from the input in “Grammar Syntax.” If the sentence(s) created from the “Grammar Syntax” field are correct, close the “Generated Sentence” dialog window by pressing the “Close” button. If the sentence(s) created from the “Grammar Syntax” field are not correct, close the “Generated Sentences” dialog window, modify the “Grammar Syntax” field, and repeat the process of checking the syntax starting with pressing the “Check Syntax” button.
If you made a syntax mistake, the “Errors” dialog window will appear listing your error. Press the “Close” button to return to the “Grammar” window to correct the grammar syntax.
If the message box “GramEdit” appears as shown below signaling that the word is missing from the dictionary, press the “Yes” button to proceed with adding a word, and the “Words Creation ([Language])” dialog window will appear. If the word and its phones are shown in the “List of Words to Add In Dictionary:” field, press “Save,” and the entry will be saved into the dictionary.
If the “List of Words to Add In Dictionary:” field only has the word without its phones, click on the word, and it will appear in the Edit List part in the “Word:” text field. Type in the phones for the word in the “Phones:” text field using the list of available phones in the “Available Phones:” field, e.g., Word: cool, Phones: k uw l. The “List of Words to Add In Dictionary:” should be simultaneously updated with the phones for the selected word.
You can add multiple entries of the same word with the different sets of phones. Click anywhere in the “List of Words to Add In Dictionary:” field to deselect entries.
When no entries are selected, type the word you are adding in the “Word:” field, and type phones in the “Phones:” field. Press the “Add as New” button, and the new entry will be added to “List of Words to Add In Dictionary:”. If you need to remove any entry, select the unwanted entry and press the “Remove” button.
When you are finished adding words and phones, press the “Save” button, and everything listed in the “List of Words to Add In Dictionary:” field will be added to the dictionary. Press “Cancel” to close the “Words Creation ([Language])” window, and check the possible phrases in the “Generated Sentences” window. Press “Close” to close the “Generated Sentences” window.
In the “Translation” text field, type the translation of the sentence that your sub-grammar will return, e.g. “[muy] bien gracias”.
When finished, press the “Next” button.
   Step 5: “Wavefile”—record the second language translation of the result of your grammar using directions described in 3.B.a., “Add a New Question,” “Wavefile” window.
The “Wavefile” text field must contain the path to your file before you press the “Next” button.
Now the system will try to submit you sub-grammar to the recognizer. If your grammar name is not unique, the “Error” dialog window will appear listing your errors. Press the “Back” button to go back and correct your errors.
When you are finished correcting any errors, press “Next” to move forward.
   Step 6: “Choice”—allows you to skip some steps when you are doing repetitive tasks. We are finished with this example, so just press the “Close” button.

d) Add a New Word to the Dictionary

Step 1: “Languages”—displays a drop-down list of available Answer languages. Select the language your answers are in even if you are only going to edit English. When finished, press the “Next” button.

Step 2: “Operation”—displays all of the operations that can be performed through the wizard. Select the “Add” radio button and then press the “Next” button.

Step 3: “Type”—displays the type of information that can be added. Select the “Word ([Language])” radio button and then press the “Next” button.

Step 4: “Word”—is the main window for adding words in the dictionary.

In the “Spelling” field, type the word that you want to add, e.g., “cool”
In the “Phones” text field, type the phonetic pronunciation of the word. Refer to the phones listed in the “Available Phones:” field, or the Appendices A-D at the end of this document. Each phone needs to be separated by a space, e.g., “k uw l”
When finished, press the “Next” button.
If you used an unspecified phone, the “Errors” dialog window will appear listing the error you made. Press the “Close” button to return to the “Word” window and correct the error. When done, press the “Next” button.
   Step 5: “Choice”—allows you to skip some steps when you are doing repetitive tasks. We are finished with this example, so just press the “Close” button.

3.C. Edit an Existing Grammar Using the Wizard

a) Edit an Existing Question

Step 1: “Languages”—displays a drop-down list of available Answer languages. Select the language your answers are in even if you are only going to edit English. When finished, press the “Next” button.

Step 2: “Operation”—displays all of the operations that can be performed through the wizard. Select the “Edit” radio button and then press the “Next” button. Step 3: “Type”—displays the type of information that can be edited. Select the “Question (English)” radio button and then press the “Next” button.

Step 4: “Select”—displays a hierarchy of topics, subtopics and questions. To find the question you want to edit, click on the related topic or its associated [+] to expand the topics tree to show subtopics. Then click on the related subtopic or its associated [+] to expand the subtopics tree to show questions. E.g., click on “Greeting/Goodbye” or its associated [+], then click on “Greeting” or its associated [+] and then select “Are you comfortable.” When finished, press the “Next” button.

Step 5: “Grammar”—this window is the main grammar-editing window.

If necessary, edit the “Recognized Text” field as appropriate. Then edit the grammar for the question by making changes to the “Grammar Syntax” text field.
After you have entered the syntax into the “Grammar Syntax” field, press the “Check Syntax” button, and the “Generated Sentences” dialog window will appear listing the sentence(s) created from the input in “Grammar Syntax.” If the sentence(s) created from the “Grammar Syntax” field are correct, close the “Generated Sentence” dialog window by pressing the “Close” button. If the sentence(s) created from the “Grammar Syntax” field are not correct, close the “Generated Sentences” dialog window, modify the “Grammar Syntax” field, and repeat the process of checking the syntax starting with pressing the “Check Syntax” button.
If you made a syntax mistake, the “Errors” dialog window will appear listing your error. Press the “Close” button to return to the “Grammar” window to correct the grammar syntax.
If the message box “GramEdit” appears telling you about words missing from the dictionary, refer to 3.B.c., “Add a New Sub-Grammar,” “Step 4: Grammar,” for explanations.
If necessary, edit the “Translation” text field by changing the sentence that your question will be translated to.
When finished, press the “Next” button.
   Step 6: “Wavefile”—edit the wave file component using directions described in 3.B.a., “Add a New Question,” “Wavefile” window. When finished, press the “Next” button.
   Step 7: “Choice”—allows you to skip some steps when you are doing repetitive tasks. We are finished with this example, so just press the “Close” button.

b) Edit an Existing Answer

Step 1: “Languages”—displays a drop-down list of available Answer languages. Select the language your answers are in even if you are only going to edit English. When finished, press the “Next” button.

Step 2: “Operation”—displays all of the operations that can be performed through the wizard. Select the “Edit” radio button and then press the “Next” button.

Step 3: “Type”—displays the type of information that can be edited. Select the “Answer (Spanish)” radio button and then press the “Next” button.

Step 4: “Select”—displays a hierarchy of topics, subtopics, questions and answers. To find the answer you want to edit, click on the related topic or its associated [+] to expand the topics tree to show subtopics. Perform the same operation on the related subtopic and question. E.g., click on “Greeting/Goodbye” or its associated [+], then click on “Greeting” or its associated [+], then click on “Are you comfortable” or its associated [+] and then click on Si si hubo. When finished, press the “Next” button.

Step 5: “Grammar”—this is the main grammar-editing window. The “Sample Sentence” text field is grayed out and cannot be changed.

If necessary, change the “Recognized Text” field or edit the grammar for the answer by making changes to the “Grammar Syntax” text field.
After you have entered the syntax into the “Grammar Syntax” field, press the “Check Syntax” button, and the “Generated Sentences” dialog window will appear listing the sentence(s) created from the input in “Grammar Syntax.” If the sentence(s) created from the “Grammar Syntax” field are correct, close the “Generated Sentence” dialog window by pressing the “Close” button. If the sentence(s) created from the “Grammar Syntax” field are not correct, close the “Generated Sentences” dialog window and modify the “Grammar Syntax” field. After modifying the “Grammar Syntax” field, repeat the process of checking the syntax starting with pressing the “Check Syntax” button.
If you made a syntax mistake, the “Errors” dialog window will appear listing your error. Press the “Close” button to return to the “Grammar” window to correct the grammar syntax.
If the message box “GramEdit” appears telling you about words missing from the dictionary, refer to 3.B.c., “Add a New Sub-Grammar,” “Step 4: Grammar,” for explanations.
If necessary, edit the “Translation” text field to reflect the sentence that your question will be translated to.
When finished, press the “Next” button.
   Step 6: “Wavefile”—edit the wave file component using directions described in 3.B.a., “Add a New Question,” “Step 6: Wavefile.” When finished, press the “Next” button.
   Step 7: “Choice”-allows you to skip some steps when you are doing repetitive tasks. We are done with this example so just press the “Close” button.

c) Edit an Existing Sub-Grammar

Step 1: “Languages”—displays a drop-down list of available Answer languages. Select the language your answers are in even if you are only going to edit English. When finished, press the “Next” button.

Step 2: “Operation”—displays all of the operations that can be performed through the wizard. Select the “Edit” radio button and then press the “Next” button.

Step 3: “Type”—displays the type of information that can be edited. Select the “Sub-Grammar ([Language])” radio button and then press the “Next” button.

Step 4: “Select”—displays a list of sub-grammars. Highlight the sub-grammar that you want to edit, e.g., click on “can_could”. When finished, press the “Next” button.

Step 5: “Grammar”—this is the main sub-grammar-editing window.

In the “Recognized Text” field, if needed, edit the phrase that will be displayed as a result of the recognition with this sub-grammar, e.g., “can_could_would”.
In the “Grammar Syntax” field, if needed, edit the grammar body, e.g., “(((can you)|(could you)|(would you)))”.
After you have entered the syntax into the “Grammar Syntax” field, press the “Check Syntax” button, and the “Generated Sentences” dialog window will appear listing the sentence(s) created from the input in “Grammar Syntax.” If the sentence(s) created from the “Grammar Syntax” field are correct, close the “Generated Sentence” dialog window by pressing the “Close” button. If the sentence(s) created from the “Grammar Syntax” field are not correct, close the “Generated Sentences” dialog window, modify the “Grammar Syntax” field, and repeat the process of checking the syntax starting with pressing the “Check Syntax” button.
If you made a syntax mistake, the “Errors” dialog window will appear listing your error. Press the “Close” button to return to the “Sub-Grammar” window to correct the grammar syntax.
If the message box “GramEdit” appears telling you about words missing from the dictionary, refer to 3.B.c., “Add a New Sub-Grammar,” “Step 4: Grammar,” for explanations.
If necessary, in the “Translation” text field, type the [Language] translation of the sentence that your sub-grammar will return.
When all text fields are successfully filled, press the “Next” button.
   Step 6: “Wavefile”—re-record or re-attach the second language translation of your resulting grammar using directions described in 3.B.a., “Add a New Question,” “Step 6: Wavefile.” The “Wavefile” text field must contain the path to your file before you press the “Next” button. The system will verify all the entered data after you press the “Next” button. If any errors occur, the “Error” dialog window will appear listing your errors. Press the “Back” button to go back and correct your errors. When you are finished correcting errors, press the “Next” button of the “Wavefile” window.
   Step 6: “Choice”—allows you to skip some steps when you are doing repetitive tasks. We are finished with this example so just press the “Close” button.
   4. Main Screen Operations
   4.A. Overview

Many of the operations described in section 3. The Wizard can be done in the main GramEdit screen without starting the Wizard. After all the changes are made, it is very important to save and compile by choosing “File→Save” from the Menu bar.

4.B. Adding a New Grammar Using Main Screen Controls

a) Add a New Question Using Main Screen

In the topics and subtopics tree, highlight the subtopic name. A subtopic is an entry with the letters ST next to it, as shown in the example: ST-Greeting. Right-click on the subtopic, and the pop-up menu will appear as shown below. Select the Add Child option, and the “Grammar” window will be displayed exactly as in the wizard. Refer to 3.B.a., “Add a New Question,” “Step 5: Grammar” and “Step 6: Wavefile” for the details on how add the question.

b) Add a New Answer Using Main Screen

In the topics and subtopics tree, highlight the question name. A question is an entry with the letter Q next to it, as shown in the example: [symbol] Q Hello how are you. Right-click on the question, and the pop-up menu will appear. Select the Add Child option, and the “Grammar” window will be displayed exactly as in the wizard. Refer to 3.B.b., “Add a New Answer,” “Step 5: Grammar” and “Step 6: Wavefile” for the details on how add the answer.

c) Add a New Sub-Grammar Using Main Screen

You can add a new sub-grammar by editing an existing question or answer.

When editing an existing question or answer, select the question or answer to be edited and then add a new sub-grammar in the Grammar Syntax field. Sub-grammars need to be preceded by the dollar sign, e.g., $grammar_to_add. Press the “Save” button in the upper left corner of the screen. The GramEdit message box will appear as shown below notifying you that this sub-grammar does not exist and asking if you want to create a new sub-grammar. Press “Yes” to create a sub-grammar with the default values.

At this point, a sub-grammar is added to the system with the default values and an empty syntax. The question or answer you just added will be in the editing part of the main screen. Below the editing part, there is a Sub-Grammars column. The sub-grammar name you just added to your question or answer is listed in this column. Double-click on the sub-grammar name, in our example, $grammar_to_add. The editing part of the main screen will be filled with the sub-grammar you just added with the default values. Modify all appropriate fields and press the “Save” button in the top-left corner of the editing part of the main screen. Refer to 3.C.c., “Edit an Existing Sub-Grammar”, Step 5: “Grammar”.

d) Add a New Word to the Dictionary Using Main Screen

When adding or editing a question, answer or sub-grammar, every word specified in the “Grammar Syntax” field is being checked against the words that are entered in the dictionary.

When adding a question, an answer or a sub-grammar with new words in the “Grammar Syntax” field, check for new words by pressing the “Next” button on the “Grammar” window.

When editing a question, an answer or a sub-grammar, the new words check is done when pressing the “Save” button on the editing part of the main screen.

The GramEdit message box will notify you that words are not in the dictionary and will ask to add those words. Press “Yes,” and the “Words Creation [language]” window will appear. The missing word(s) and suggested pronunciation are displayed in “Words to add in dictionary:”. To add a word, type the word in the “Word:” text field, and type its phonetic pronunciation, referring to the list of phones in “Available phones:” e.g., Word: cool, Phones: k uw l.

Press the “Add As New Word” button, and the word and its phones move into the “Words to add in dictionary” area. Press the “Save” button to save the word in the dictionary.

If the “Words to add in dictionary:” field only has a word without its phones, click on the word, and it will appear in the “Word:” text field. Type in the phones for this word in the “Phones:” text field, using the list of available phones in the “Available Phones:” field. When finished, press “Update Selected Word.” The phones will appear next to the word in “Words to add in dictionary:” Press “Save” to save the word in the dictionary.

You can add multiple entries of the same word with the different sets of phones. The buttons “Remove Selected Word,” “Update Selected Word,” and “Add Selected Word” are managing the appearance of different versions of the same word in the “Words to add in dictionary:” field. For the screen shot of the window refer to the section 3.B.c., “Add a New Sub-Grammar,” “Step 4: Grammar”.

e) Add a New Topic Using Main Screen

In the topics and subtopics tree, right-click on a domain you want to add a topic to. Domains are the entries with the D next to them. The pop-up menu appears. Select the Add Child option, and the “Name” window will be displayed. Type the name of the topic in the text field and press “Next” button. Press the “Close” button on the “Choice” window. The main screen displays the newly created topic; it is highlighted in the topics and subtopics tree, it is in the editing part of the main screen, and the Domain Sets column displays its parent's list.

To enable the voice navigation to this topic, you must record a Wavefile in English with the name of the topic and specify a Grammar Syntax allowing for different ways of saying the name of the topic. When words are missing from the dictionary, refer to 4.B.d., “Add a New Word to the Dictionary Using Main Screen” and 3.B.c., “Add a New Sub-Grammar,” “Step 4: Grammar.”

For example, to add a topic named Test and Try to the Force Protection domain:
Right click Force Protection domain name
Choose Add Child
Type Test and Try and press “Next”
Press “Close”
On the main screen, record “Test and Try” (refer to 3.B.a., “Add a New Question,” “Step 6: Wavefile”)
In the Grammar Syntax: ((test and try)|test|try)
Press “Save”

f) Add a New Subtopic Using Main Screen

In the topics and subtopics tree, right-click on a topic you want to add a subtopic to. Topics are the entries with the T next to them. The pop-up menu appears. Select the Add Child option, and the “Name” window will be displayed. Type the name of the subtopic in the text field, and press “Next” button. Press the “Close” button on the “Choice” window. The main screen displays the newly created subtopic; it is highlighted in the topics and subtopics tree, it is in the editing part of the main screen, and the Topics column displays its parent's list.

To enable the voice navigation to this subtopic, you must record a Wavefile in English with the name of the subtopic and specify a Grammar Syntax allowing for different ways of saying the name of the subtopic. When words are missing from the dictionary, refer to 4.B.d., “Add a New Word to the Dictionary Using Main Screen”, and 3.B.c., “Add a New Sub-Grammar,” “Step 4: Grammar.”

For example, to add a subtopic named Try This to the Test and Try domain:
Right click the Test and Try domain name
Select Add Child
Type Try This and press “Next”
Press “Close”
On the main screen, record “Try This” (refer to 3.B.a, “Add a New Question,” “Step 6: Wavefile”)
In the Grammar Syntax: (try this)
Press “Save”

4.C. Editing an Existing Grammar Using the Main Screen

a) Edit an Existing Question Using the Main Screen

Select a question in the topics and subtopics tree. A question is the entry with the Q next to it. The details about the question will be shown in the editing part of the main screen, e.g., select the question “How are you.”

Edit necessary fields. Fields available for editing are “Recognized Text,” “Translation,” “Wavefile” and “Grammar Syntax.” If you need to add words, press the “Add Word” button and refer to 4.B.d., “Add a New Word to the Dictionary Using Main Screen”, and 3.B.c., “Add a New Sub-Grammar,” “Step 4: Grammar.” There is a Hide check box in the right upper corner of the editing part of the screen. When the Hide box is checked, the question is not displayed on the S-Minds screen (refer to the S-Minds_Users_Manual.doc) but can still be spoken and recognized.

When finished, press the “Check Syntax” button to verify the changes. If an “Error” window appears, correct the errors. If a new grammar needs to be created, refer to 4.B.c., “Add a New Sub-Grammar Using Main Screen.” If the sub-grammars used in the question need to be modified, double-click on the sub-grammar name in the Sub-Grammars column below the editing part of the screen and refer to 4.C.c., “Edit an Existing Sub-Grammar Using Main Screen”

After all modifications are entered, press the “Save” button in the top-left corner.

b) Edit an Existing Answer Using the Main Screen

Select an answer in the topics and subtopics tree. An answer is the entry with the A next to it. The details about the answer will be shown in the editing part of the main screen, e.g., select the question, “Estoy bien gracias”.

Edit needed fields. Fields available for editing are “Recognized Text,” “Translation,” “Wavefile” and “Grammar Syntax.” If you need to add words, press the “Add Word” button and refer to 4.B.d., “Add a New Word to the Dictionary Using Main Screen”, and 3.B.c., “Add a New Sub-Grammar,” “Step 4: Grammar.” There is a Hide check box in the right upper corner of the editing part of the screen. When the Hide box is checked, the question is not displayed on the S-Minds screen (refer to the S-Minds_Users_Manual.doc) but can still be spoken and recognized.

When finished, press the “Check Syntax” button to verify the changes. If an “Error” window appears, correct the errors. If a new grammar needs to be created, refer to 4.B.c., “Add a New Sub-Grammar Using Main Screen.” If the sub-grammars used in the question need to be modified, double-click on the sub-grammar name in the Sub-Grammars column below the editing part of the screen and refer to 4.C.c., “Edit an Existing Sub-Grammar Using Main Screen.”

After all modifications are entered, press the “Save” button in the top-left corner.

c) Edit an Existing Sub-Grammar Using the Main Screen

To access the existing sub-grammar from the main screen, select a question or an answer in which the sub-grammar is used. The sub-grammars will be listed in the Sub-Grammar column below the editing part on the main screen.

Double-click on the sub-grammar name, and the editing part of the main screen will be filled with the details of the sub-grammar. Change the needed information. To add words, refer to 4.B.d., “Add a New Word to the Dictionary Using Main Screen”, and 3.B.c., “Add a New Sub-Grammar,” “Step 4: Grammar.”

When finished, press the “Check Syntax” button to verify the changes. If an “Error” window appears, correct the errors. If a new grammar needs to be created, refer to 4.B.c., “Add a New Sub-Grammar Using Main Screen” If the sub-grammars used in the answer need to be modified, double-click on the sub-grammar name in the Sub-Grammars column below the editing part of the screen to display this grammar on the screen.

There is a List check box in the top right corner of the editing part of the screen. A list is a sub-grammar of the form ($a|$b|$c) and can be edited from S-Minds. If you have a sub-grammar that has this format and want a user to be able to edit it from S-Minds, check the List box. For example, if you have a question that can be applied to many different names, your sub-grammar $names will have ($John_Smith|$Mike_White|$Susan_Brown) in its “Grammar Syntax” field.

After all modifications are entered, press the “Save” button in the top left corner.

d) Edit an Existing Domain, Topic and Subtopic Using the Main Screen

Highlight the domain, topic or subtopic name in the topics and subtopics tree, and the editing part of the screen will display the details of the selected component. All three components have two fields for editing, “WaveFile” and “Grammar Syntax.” For topics and subtopics, the name can also be changed. It is important to remember when you change the name that the “Grammar Syntax” and “WaveFile” must be updated. If needed, re-record the wavefile or edit the grammar, and press the “Save” button in the top left corner.

4.D. Copy, Link, Move, and Order Children Options for the Topics and Subtopics Tree

a) Overview

The Copy, Link and Move options can be applied to topics, subtopics, questions and answers. The Order Children options is applied to topics, subtopics, and questions.

The Copy option makes an independent copy of the component, which means that editing this component will only affect the copied component. The children of the copied component will be copied as well.

The Link option creates a link, or reference, of the component to another parent. When components are linked, no independent copy is made, which means that the same component is displayed in two or more different places on the screen. Any editing operation will affect all of the places where the component is referenced.

The Move option creates a copy of the selected component and deletes the original. The children of the moved component will be moved as well.

The Order Children option re-arranges the appearance of children of the selected parent on the screen. For the tree organization, refer to 2.C.b., “Tree Hierarchy of Topics, Subtopics, Questions and Answers.”

b) Copy

Copy Topic

Highlight the topic you want to make a copy of in the topics and subtopics tree by right-clicking on it and select the Copy option. Then, right-click on the parent—the domain that you want the topic copied to—and select the Paste option. All the children of the topic, namely subtopics, questions and answers, will be copied to the new topic. The new topic will have the same name as the original topic with the number 1 added after the name. You must rename the copy of the topic, record the wave file and change the topic's grammar according to the new name for the voice navigation.

Another way to copy a topic is to click-and-hold on it using the left mouse button and drag the topic to the domain you want to copy it to. Release the mouse button when the destination domain name is highlighted. When the pop-up menu appears, select the Copy option.

Copy Subtopic

Highlight the topic you want to make a copy of in the topics and subtopics tree by right clicking on it and select the Copy option. Then, right-click on the parent—the topic that you want the subtopic to be copied to—and choose the Paste option. The children of the subtopic, namely questions and answers, will be copied to the new topic. The new subtopic will have the same name as the original subtopic with the number 1 added after the name. You must rename the copy of the subtopic, record the wave file and change the topic's grammar according to the new name for the voice navigation.

Another way to copy a subtopic is to click-and-hold on it using the left mouse button and drag the subtopic to the topic you want to copy it to. Release the mouse button when the destination topic name is highlighted. When the pop-up menu appears, select the Copy option.

Copy Question

Highlight the question you want to make a copy of in the topics and subtopics tree by right-clicking on it and select the Copy option. Then, right-click on the parent—the subtopic that you want the question to be copied to—and select the Paste option. The children of the question, namely answers, will be copied to the new subtopic. The new question will have the same name as the original question with the number 1 added after the name. You must edit the copy of a question in such a way that the unique sample sentence will be generated on save; otherwise, copying is not necessary, and it is recommended to use Link instead.

Another way to copy a question is to click-and-hold on it using the left mouse button and drag the question to the subtopic you want to copy it to. Release the mouse button when the destination subtopic name is highlighted. When the pop-up menu appears, select the Copy option.

Copy Answer

Highlight the answer you want to make a copy of in the topics and subtopics tree by right-clicking on it and select the Copy option. Then, right-click on the parent—the question that you want the answer to be copied to—and select the Paste option. The new answer will have the same name as the original answer with the number 1 added after the name. You must edit the copy of an answer in such a way that the unique sample sentence will be generated on save; otherwise, copying is not necessary, and it is recommended to use Link instead.

Another way to copy an answer is to click-and-hold on it using the left mouse button and drag the answer to the question you want to copy it to. Release the mouse button when the destination question name is highlighted. When the pop-up menu appears, select the Copy option.

c) Link

Link Topic

Right-click on the topic that you want to make a link to, and select the Link option. Right-click on the parent—a domain that will have a link to the topic—and select the Paste option. You cannot link a topic to the same parent (domain) that the topic is currently in. Because linking is referencing the same topic from different parents (domains), editing any linked topic will affect all the places in which the topic is referenced.

On the main screen below the editing part, there are three columns. When a topic is highlighted in the topics and subtopics tree, the first column displays parent(s) of a topic (domain sets(s)), and the second column displays children of a topic (subtopic(s)). The number of parents listed in the first column tells you every place from which the topic is referenced, so any location you choose to edit will affect all others. For example, if you change the name of the topic in one place, all other places that have a link to that topic will have a new name.

Another way to link a topic is to click-and-hold on it using the left mouse button and drag it to the domain you want to link the topic to. Release the mouse button when the destination domain name is highlighted. When the pop-up menu appears, choose the option Link.

Link Subtopic

Right-click on the subtopic that you want to make a link to, and select the Link option. Right-click on the parent—a topic, which will have a link to the subtopic, and select the Paste option. You cannot link a subtopic to the same parent (topic) that the subtopic is currently in. Because linking is referencing the same subtopic from different parents (topics), editing any linked subtopic will affect all the places in which the topic is referenced.

On the main screen below the editing part, there are three columns. When a subtopic is highlighted in the topics and subtopics tree, the first column displays parent(s) of a subtopic (topics(s)), and the second column displays children of a subtopic (question(s)). The number of parents listed in the first column tells you every place from which the topic is referenced, so any location you choose to edit will affect all others. For example, if you change the name of the subtopic in one place, all other places that have a link to that subtopic will also have a new name.

Another way to link a subtopic is to click-and-hold on it using the left mouse button and drag it to the domain you want to link the topic to. Release the mouse button when the destination topic name is highlighted. When the pop-up menu appears, choose the Link option.

Link Question

Right-click on the question that you want to make a link to, and select the Link option. Right-click on the parent—a subtopic—which will have a link to the question, and select the Paste option. You cannot link a question to the same parent (subtopic) that the question is currently in. Because linking is referencing the same question from different parents (subtopics), editing any linked question will affect all the places in which the topic is referenced.

On the main screen below the editing part, there are three columns. When a question is highlighted in the topics and subtopics tree, the first column displays parent(s) of a question (subtopics(s)), and the second column displays children of a question (answer(s)). The number of parents listed in the first column tells you every place from which the question is referenced, so any location you choose to edit will affect all others. For example, if you change the name of the question in one place, all other places that have a link to that question will also have a new name.

Another way to link a question is to single-click on it using the left mouse button and dragging it to the subtopic you want to link the question to. Release the mouse button when the destination subtopic name is highlighted. When the pop-up menu appears, choose the Link option.

Link Answer

Right-click on the answer that you want to make a link to, and select the Link option. Right-click on the parent—a question, which will have a link to the answer, and select the Paste option. You cannot link an answer to the same parent (question) that the answer is currently in. Because linking is referencing the same answer from different parents (questions), editing any linked question will affect all the places in which the topic is referenced.

On the main screen below the editing part, there are three columns. When an answer is highlighted in the topics and subtopics tree, the first column displays parent(s) of an answer (question(s)). The number of parents listed in the first column tells you every place from which the answer is referenced, so any location you choose to edit will affect all others. For example, if you change the wavefile of the answer in one place, all other places that have a link to that answer will also play a new wavefile for the translation.

Another way to link an answer is to click-and-hold on it using the left mouse button and drag it to the question you want to link the answer to. Release the mouse button when the destination question name is highlighted. When the pop-up menu appears, choose the Link option.

d) Move

Move Topic

Right-click on the topic you want to move to a different domain, and choose the Move option. Right-click on the domain that you want to move the topic to, and select the Paste option. The children will move to the new location, and the topic will be deleted from the original location.

Another way to move a topic is to click-and-hold on it using the left mouse button and drag the topic to the domain you want to move it to. Release the mouse button when the destination domain name is highlighted. When the pop-up menu appears, select the Move option.

Move Subtopic

Right-click on the subtopic you want to move to a different topic, and select the Move option. Right-click on the topic that you want to move the subtopic to, and select the Paste option. The children will move to the new location, and the subtopic will be deleted from the original location.

Another way to move a subtopic is to click-and-hold on it using the left mouse button and drag the subtopic to the topic you want to move it to. Release the mouse button when the destination topic name is highlighted. When the pop-up menu appears, select the Move option.

Move Question

Right-click on the question you want to move to a different subtopic, and select the Move option. Right-click on the subtopic that you want to move the question to, and select the Paste option. The children will move to the new location, and the question will be deleted from the original location.

Another way to move a question is to click-and-hold on it using the left mouse button and drag the question to the subtopic you want to move it to. Release the mouse button when the destination subtopic name is highlighted. When the pop-up menu appears, select the Move option.

Move Answer

Right-click on the answer you want to move to a different question, and select the Move option. Right-click on the question that you want to move the answer to, and select the Paste option. The answer will be deleted from the original location.

Another way to move an answer is to click-and-hold on it using the left mouse button and drag the answer to the question you want to move it to. Release the mouse button when the destination question name is highlighted. When the pop-up menu appears, select the Move option.

e) Order of Children

Order of Topics

To change the order of appearance of topics on the screen, right-click on the topics' parent (domain), and select the Order Children option. The “Order” window will appear listing topics eligible for ordering. Highlight and move one topic at a time using the buttons to the left of the list. After all re-arrangements are complete, press the “Next” button, and close the “Choice” window.

Order of Subtopics

To change the order of appearance of subtopics on the screen, right-click on the subtopics' parent (topic), and select the Order Children option. The “Order” window will appear listing subtopics eligible for ordering. Highlight and move one subtopic(s) at a time using the buttons to the left of the list. After all re-arrangements are complete, press the “Next” button, and close the “Choice” window.

Order of Questions

To change the order of appearance of questions on the screen, right-click on the questions' parent (subtopic), and select the Order Children option. The “Order” window will appear listing questions eligible for ordering. Highlight and move one question at a time using the buttons to the left of the list. After all re-arrangements are complete, press the “Next” button, and close the “Choice” window.

Order of Answers

To change the order of appearance of answers on the screen, right-click on the answers' parent (question), and select the Order Children option. The “Order” window will appear listing answers eligible for ordering. Highlight and move one answer at a time using the buttons on the left of the list. After all needed re-arrangements are complete, press the “Next” button, and close the “Choice” window.

5. Operations with Tools Menu

5.A. Language Operations

a) Add a New Language

To add a new language to the system, select the “Tools→Add Language” option, and the “Language Creation” window will appear. Type the name of the new language in the text field and press the OK button. The GramEdit splash screen will appear while the system is adding a new language. When the splash screen is gone, the main screen displays the new language with the default domain set already added. You can start setting up topics and subtopics manually by right clicking on the domain name in the topics and subtopics tree and selecting the Add Child option. Alternatively, if the new language will have the same set or subset of questions that an existing language has, you can import questions into the system (refer to 5.B.c., “Full Import”). Note: only one way questions can be added to the system.

b) Change Language

To change the language to start working with another language, select “Tools→Change Language,” and the “Language Selection” window will appear. The drop-down list shows all the languages in the system. Select another language and press the OK button. The GramEdit splash screen will appear while the system is changing the language. When the splash screen is gone, the system will be changed to work with the chosen language.

5.B. Full Import and Full Export

a) Overview

Full Import and Full Export are the two utilities that allow copying questions between languages along with question grammars. Because the question language is always English, these tools are very helpful for setting up a new language, if the translation of the same set of questions is required. For example, when you are adding a new language and you need to translate questions that already exist in another language, you do a full export of questions, and questions, grammars, dictionaries and voice navigation wave files are saved into files. Then you can give a question file to a linguist to translate into a new language. The created questions file has the ID numbers of the questions, which simplifies the process of entering the translations into the system. The exported questions can be imported into the new language. When imported, all English questions with grammars are copied into the preserved tree structure, showing the same set of topics and subtopics in the tree.

b) Full Export

Make sure the system is in the language that you want to export questions from. You can see what second language is being used at the top left corner of the Menu bar, e.g., GramEdit (Spanish). Select “Tools→Full Export” and the “Export Questions” window appears. By default, all the questions of the current domain are displayed in the window. You can switch the domains by selecting a different domain name from the “Domain Set:” drop-down list. The All option in the Domain Set will display all questions in all domains. If you need to export only the questions that belong to a particular topic, select the topic name from the “Topic:” drop-down list. If you need to export the questions of a particular subtopic, select the name of the subtopic from the “Subtopic:” drop-down list.

The questions for export should appear in the “Export List:” of the “Destination:” half of the window. To achieve that, highlight questions for export and press the Add>> button. The list of questions will appear in the “Export List:” Press the “Export” button, and the “Save As” window will appear. Type in the name of the exported question and press the “Save” button. The export is complete, and you can press the “Exit” button. The files with all the questions, grammars and dictionaries exported are in the directory that was created with the specified name. The questions are in the location <name>/english/english.qq.

c) Full Import

Make sure you have changed the language to the one to import questions to. The second language is indicated in the top left corner of the Menu bar on the main screen, e.g., GramEdit (Spanish). Select “Tools→Full Import,” and the “Open” dialog box appears. The directory name for your exported questions is shown in the box. Double-click on the folder and find the “.fge” file inside of the folder. Select the “.fge” file and press the “Open” button.

If the GramEdit dialog box appears asking if you want to overwrite existing components, press Yes. The overwriting occurs on the ID basis, which means that if there is a question in the system with the same ID as the one being imported, the first will be overwritten, even if the questions themselves are different. When the import is complete, the topics and subtopics tree will have the topics, subtopics and questions that you chose to import.

5.C. Operations with Questions

a) Assign Questions

Assign Questions performs the same operation as the options copy, move and link, described in the section Copy, Link, Move and Order Children Operations for the Topics and Subtopics Tree, but allows you to select multiple questions for these operations.

Select “Tools→Assign Questions,” and the “Assign Questions” window appears. The window is divided in halves vertically. The left half is the “Source:” and the right half is the “Destination:”. Each half has three drop-down lists: Domain Set, Topic and Subtopic, and the list of questions. The default setting shows the same set of questions in both halves.

To find questions that need to be assigned to a different subtopic, use the three drop-down lists in the “Source:” half to select the domain, then topic, and then subtopic. The questions of the selected subtopic will be displayed in the window.

To select the destination, use the three drop-down lists on the “Destination:” half to select the subtopic the questions will be assigned to. Note that the source and destination locations must be different. Highlight the questions in the Source list that need to be assigned to a “Destination:” parent. Then select one of the three operations: Move>>, Link>>, or Copy>> and press the corresponding button, located between the two halves. You can remove or delete questions from the destination list using the button Remove<<. You can also return questions to the source list in a Move>> operation using Move Back<<. When finished assigning questions, press the “Exit” button. All of the changes will take affect only after you select “File→Save” from the Menu bar.

There are a few cautions about this operation. When you move a question from one subtopic to another, and then decide to Remove<< the question from the destination list, the question will be deleted from both subtopics and from the system if there are no links to this question. Therefore, use Move Back<< to reverse the move. When you link a question from one subtopic to another and decide to Remove<<the question from the destination list, the question will be deleted from the list view but not from the system, and you will need to restart the Assign Question window to see that question in the list again.

b) Export Questions

Export Questions allows exporting selected questions into the flat file. When questions are exported, they are saved in the file along with the translation and path to the wavefile. The exported questions do not keep the parent information.

Select “Tools→Export Questions,” and the “Export Questions” window appears. The window is divided in halves vertically. The left half is the “Source:” and the right half is the “Destination:”.

The “Source:” half has three drop-down lists: Domain Set, Topic and Sub-Topic, and the list of questions. To find questions that need to be exported, use the three drop-down lists in the “Source:” half to select the domain, then topic, and then subtopic. The questions of the selected subtopic will be displayed in the window. The All option in the Domain Set will display all question in all domains. Select the questions for export in the Source list, and press the button Add>>. The selected questions appear in the “Destination:” half. Use the Remove<< button to exclude questions from the “Destination:” list. When finished selecting questions, press “Export,” and the “Save As” window appears. Type the file name and press “Save.” Press “Exit” to close the “Export Questions” window.

c) Import Questions

Select “Tools→Import Questions,” and the “Import Questions” window appears. The window is divided in halves vertically. The left half is the “Source:” and the right half is the “Destination:.”

To display questions to be imported, press the Import button, and the “Open” dialog box appears. Select the “.pge” file and press the Open button. The GramEdit box appears asking if you want to import only questions. If you are importing questions from the different language, press the Yes button, because you don't want to have answers in the second language that are not in the current language. If you are importing questions with the answers in the same language as your current second language, press No.

The “Destination:” half has three drop-down lists: Domain Set, Topic and Subtopic, and the list of questions. To find the location for questions that are being imported, use the three drop-down lists in the “Destination:” half to select the domain, then topic, and then subtopic. The questions of the selected subtopic will be displayed in the window.

Select the questions in the “Source:” list and press the button Move>> or Copy>>. The selected questions appear in the “Destination:” half. Use the Remove<< button to exclude questions from the “Destination:” list. When pressing the Move>> button, the questions are being deleted from the “Source:” list and moved to the “Destination:” list. If you choose to Remove<< the question from the “Destination:” list, the question will not be displayed in the “Source:” list. To display the “Source:” question back, press the “Import” button again. If you need to add words, press the “Add Word” button and refer to 4.B.d., “Add a New Word to the Dictionary Using Main Screen”, and 3.B.c., “Add a New Sub-Grammar,” “Step 4: Grammar.” When finished, press “Exit” to close the Import Questions window.

5.D. Searching and Editing an Existing Grammar Using the Tools Menu

To edit the existing question, answer or sub-grammars using the “Tools” menu, select the “Tools” menu and the appropriate option.

a) Search For an Existing Question Using the Tools Menu

Select “Tools→Edit Question,” and the “Question Editing” window will appear. By default, all questions in the current domain will be displayed. To display all the questions in the system, choose “All” from the drop-down list below “Domain:”

If you know what topic the question belongs to, you can find it by selecting the topic name from the “Topic:” drop-down field, and the set of questions will change to the questions that belong to the chosen topic only, e.g., from “Topic:” select Greeting/Goodbye. Questions in the window are the questions used in the Greeting/Goodbye.

You can further limit the number of questions displayed by selecting a subtopic name from the “Subtopic:” drop-down menu, e.g., from “Subtopic:” select Greeting. Questions displayed in the window are the questions used in the Greeting subtopic

Questions can be alphabetically ordered by clicking on the Question bar on the top of the list of questions.

You can search for the questions containing specific words in any of its fields. To activate the search, select one of the fields named in the drop-down “Search by:” field on the bottom of the window. The fields being searched are Question, Recognized Text, Translation, Syntax or All Fields. In the text field to the left of the “Search” button, type the word or phrase to search for, and press the “Search” button. E.g.:
From “Search by:” select Syntax
In the text field to the left of the “Search” button, type: languages
Press the “Search” button
The questions displayed in the window have the word languages in their Syntaxes.

NOTE: If you specified a topic and subtopic on the ton of the window, the search will be conducted only within the selected topic and subtopic.

After locating the question in the system, highlight it and press the “Exit” button. The main screen of GramEdit will be updated, showing this question in the topic and subtopic tree, as well as in the editing part of the main screen.

b) Edit an Existing Question Using the Tools Menu

Select “Tools→Edit Question,” and the “Question Editing” window will appear as shown above. To locate the question to be edited, refer to 5.D.a., “Search for an Existing Question Using the Tools Menu.” Once the question is found and highlighted in the “Question Editing” window, DO NOT press Exit. The highlighted question fills the editing part of this window with its details. You can modify the “Recognized Text,” “Translation,” “Wavefile,” and “Grammar Syntax” fields. The “Check Syntax” and “Add Word” buttons work as described in 3.B.c., “Add a New Sub-Grammar.” Press the “Save” button when finished editing.

If you exited from the “Question Editing” window, the question you searched for will be displayed on the main screen, so you can edit it from there. Refer to 4.C.a., “Edit an Existing Question Using Main Screen,” for details.

c) Search and Edit an Existing Answer Using the Tools Menu

Select “Tools→Edit Answer,” and the “Answer Editing” window will appear. This window works exactly the same as the “Question Editing” window described in the previous sections, “Search for an Existing Question Using the Tools Menu” for searching, and “Edit an Existing Question Using the Tools Menu” for editing.

d) Search and Edit an Existing Question Sub-Grammars Using the Tools Menu

Select “Tools→Edit Question Sub-Grammars,” and the “English Sub-Grammars Editing” window will appear. This window works exactly the same as the “Question Editing” window described in the previous sections, “Search for an Existing Question Using the Tools Menu” for searching, and “Edit an Existing Question Using the Tools Menu” for editing.

The grammars displayed in this window are the top-level grammars used in the questions. Sub-grammars that are used only in other grammars are not displayed. To display all sub-grammars in the system for the current language, click on the drop-down menu below “Domain:” and choose “All” option. The list of sub-grammars will be updated. To edit nested sub-grammars refer to 3.C.c., “Edit an Existing Sub-Grammar” or 4.C.c., “Edit an Existing Sub-Grammar Using the Main Screen.”

Advanced Operations

7.A. Deleting Languages

The initialization file “Gram.ini” located in S-MINDS\Minds directory specifies settings for languages, recognizers and compilation components. Changing recognizers is irrelevant to the GramEdit tool, and is described in detail in the S-Minds Users Manual. All of the languages supported by the system are listed in the [LANGUAGES] section of the “Gram.ini” file. Below is the example of this section in its original state. If you add a language, the LANG_NBR will be incremented, and the extra line will appear reflecting the name of the language just added. There is no feature that allows a language to be deleted from the system through the GramEdit application; therefore, deleting a language is done by manually modifying the “Gram.ini” file.

[LANGUAGES]

LANG_NBR = 5
LANG_NAME_1 = ENGLISH
LANG_NAME_2 = SPANISH
LANG_NAME_3 = SERBO
LANG_NAME_4 = ARABIC
LANG_NAME_5 = CHINESE

To remove a language:
From the [PATH] section, remove the path that points to the language being removed.
From the [LANGUAGES] section, decrement the LANG_NBR value and remove the
LANG_NAME_corresponding to the language name being removed.
Make sure there are no gaps in the numbers in the LANG_NAME_. If there is, change the LANG_NAME_to end with consecutive numbers
   7.B. Switching Masterpackages

In the “Gram.ini” file, [MASTERPACKAGES] section shown below, the two alternate recognition packages for Spanish are listed. The line starting with “//” is the package that is not used in the current setting. To switch packages, move “//” to the other line. The package, which is not used in the example below, has the acoustic models of non-native speakers.

[MASTERPACKAGES]

SPANISH = “spanish-16K-gen-na-970915”
//SPANISH = “spanish-16K-gen-na+nn-970915”

7. C. Specifying Order For Sub-Grammars

Defining and editing grammars in GramEdit is described in sections 3.B.c and 3.C.c above. As an advanced feature of editing grammars, users can define order for each sub-grammar. By doing this, after recognition, a translation of each sub-grammar appears according to the order specified, and not in the order of sub-grammars used. For example, in case of no order specified, the grammar in English (Note: Recognized Text chunks correspond to Translation chunks)

Grammar Syntax: $what_color $were_are $persons_eyes
Recognized Text: what color ----- were ------- the person's eyes
Translation in Japanese: [symbol] --- [symbol] ---

[symbol]

The correct translation is:

[symbol]

Meaning in English: the person's eyes—what color—were

The example above shows that translating each chunk of English sentence and putting them in the same order, as English chunks cannot achieve the correct translation. The example below shows how to achieve the correct translation using order numbers.

Grammar Syntax: $what_color: 2 $were_are: 3 $persons_eyes: 1
Recognized Text: what color were the person's eyes
Translation in Japanese: [symbol] -- [symbol] -- [symbol]
Literal meaning in English: the person's eyes ---- what color --- were

In the example above, the numbers next to grammar names specify what place in the sentence each translation will take.

The numbers used for the order can be between 1 and 32. If any of the grammars in the hierarchy have order, all grammars must have an order. If there is only one sub-grammar used, it's required to say $grammar: 1. If a grammar represented as a list, order is specified as follows: ($blue:1|$red:1|$green:1).

8. Appendices

Appendix A: Sample GramEdit Demo

Getting Started

Find the GramEdit shortcut on your desktop and double-click on it.

2. Add The Question “What's up” to the Sub-topic “Greeting”

a) In the Topics pane, double-click on the Force Protection.

b) Change the topic to Greeting/Goodbye and sub-topic to Greeting.

c) Right-click on the sub-topic Greeting and select Add Child.

d) In the Recognized Text field, type “what's up”.

e) In the Grammar Syntax field, type “(what's up)”.

f) In the Translation field, type “que pasa”, and press Next.

g) Press the Record button, say “que pasa” and press Stop Recording.

h) Press Next.

i) On the Choice window, press Close.

3. Edit The Question ‘What’s up” to “What's up Man”

Make sure the topic Greeting/Goodbye and subtopic Greeting is chosen in the Topics pane, and the question “What's up” is highlighted.

a) In the editing part of the screen, locate the Grammar Syntax field.

b) Edit the Grammar Syntax field to say “(what's up $man)”.

c) Press Save and press Yes on the GramEdit dialog box.

d) In the Sub-Grammars column, double-click on “man”.

e) In the Translation field, type “amigo”.

f) Press the Record button and say “amigo” and then press Stop Recording.

g) In the Grammar Syntax field, type “(man)”.

h) Press Save.

4. Add The Answer “Nada” to the question “what's up man”

Make sure the topic Greeting/Goodbye and subtopic Greeting is chosen in the Topics pane, and the question “What's up” is highlighted.

a) Right-click on the question “What's up man” and select “Add Child”.

b) In the Recognized Text field, type “nada”.

c) In the Grammar Syntax field, type “(nada (asi [asi]))”.

d) In the Translation text field, type “not much” and press Next.

e) Press the Record button and say “not much” and then press Stop Recording.

f) Press Next.

g) In the Choice window, press Close.

h) In the Editing part of the screen, press Check Syntax to view possible answers.

5. Link the question “What's up” to the topic “Goodbye”

a) Right-click on the question “What's up man” and select Link from the menu.

b) Right-click on the sub-topic Goodbye and select Paste from the menu.

6. Save Changes

Select File→Save to save all changes.

APPENDIX B
English Phones

| Symbol | Example |
|---|---|
| Vowels | |
| aa | b[al]m or b[o]x |
| ae | b[a]t |
| ah | b[u]t |
| ao | b[ou]ght |
| aw | b[ou]t |
| ax | [a]bout |
| ay | b[i]te |
| eh | b[e]t |
| er | b[ir]d |
| ey | b[ai]t |
| ih | b[i]t |
| iy | b[ee]t |
| ow | b[oa]t |
| oy | b[oy] |
| uh | b[oo]k |
| uw | b[oo]t |
| Semi-Vowels | |
| l | [l]ed |
| r | [r]ed |
| w | [w]ed |
| y | [y]et |
| hh | [h]at |
| Plosives | |
| b | [b]et |
| d | [d]ebt |
| g | [g]et |
| k | [c]at |
| p | [p]et |
| t | [t]at |
| Fricatives | |
| dh | [th]at |
| th | [th]in |
| f | [f]an |
| v | [v]an |
| s | [s]ue |
| sh | [sh]oe |
| z | [z]oo |
| zh | mea[s]ure |
| Affricates | |
| ch | [ch]eap |
| jh | [j]eep |
| Nasals | |
| m | [m]et |
| n | [n]et |
| en | butt[on] |
| ng | thi[ng] |
| Silence | |
| sil | silence |
| sp | short pause |

APPENDIX C
Spanish Phones

| Symbol | Example |
|---|---|
| Vowels | |
| i | s[i] |
| e | b[e]stia |
| A | b[a]rro |
| o | b[o]tes |
| u | b[u]que |
| Stops | |
| p | [p]ollo |
| t | [t]asa |
| k | [c]abo |
| b | [v]aca, a[b]ajo |
| d | [d]os, acce[d]er |
| g | [g]ato, a[g]achan |
| Tap and trill | |
| ! | pe[r]o |
| r | pe[rr]o |
| Nasals | |
| m | [m]ano |
| n | [n]o |
| N | ara[n]a |
| Fricatives | |
| f | [f]aja |
| s | [s]ala |
| x | e[g]ipcio, ba[j]a |
| Affricates | |
| tS | [ch]ivo |
| Approximants | |
| j | po[ll]o |
| w | ab[u]elo |
| l | [l]oco |
| Silence | |
| sil | silence |
| sp | short pause |

APPENDIX D
Serbo-Croatian Phones

| | Example |
|---|---|
| # Symbol | |
| a | NEK(A) |
| aa | T(A) |
| b | (B)RADA |
| c | (C)RNA |
| ch | (C′)EMO |
| cx | (C\hat{ })ITAM |
| d | (D)AN |
| dx | DOVI(D′)ENJA |
| dz | (D)EP |
| e | (E)NGL(E)SKI |
| ee | MJES(E)CI |
| f | UNI(F)ORMA |
| g | (G)OSPODAR |
| h | (H)RVAT |
| i | (I)ZVOL(I)TE |
| ii | N(I)JE |
| j | STANU(J)EM |
| k | VISO(K) |
| l | ZE(L)ENE |
| lj | (LJ)EPA |
| m | I(M)A |
| n | (N)E |
| nj | (NJ)EGOVA |
| o | N(O)SI |
| oo | (O)NI |
| p | (P)O(P)ODNE |
| r | P(R)IJE |
| rr | P(R)VA |
| rx | (R)ASTAVLJEN |
| s | (S)AM |
| sh | VARO(S) |
| t | (T)AMO |
| u | J(U)NA |
| uu | T(U) |
| v | (V)IDIO |
| z | (Z)BOGON |
| zh | (Z)IVIM |
| # Silence | |
| sil | silence |
| sp | short pause |

Appendix E: Installation of Foreign Keyboard

This procedure will allow you to install additional languages in Windows 2000.

To Add a Language

1. Click Start, Settings, Control Panel.

2. Open Regional Options.

3. In the General tab, look at the bottom section (Language settings for the system).

4. Check all the languages you need.

5. Click OK.

6. Reboot the computer if necessary.

Some languages you might need are Arabic, Cyrillic or simplified Chinese.

To Add a Keyboard Layout

Click Start, Settings, Control Panel.
Open Regional Options or Keyboard.
In the Input Locales tab, look at the top section (Installed input locales).
Click the Add . . . button.
In the Add Input Locale dialog, select the Input locale and Keyboard Layout/IME that you need.
Click OK when finished.
Repeat steps 4 through 6 as needed.
Check the Enable indicator on taskbar, at the bottom of the dialog.
Click OK and reboot the computer if necessary.

Some keyboard layout you might need:

| Abbreviation | Input Locale | Keyboard Layout |
|---|---|---|
| AR | Arabic (Saudi Arabia) | Arabic (101) |
| SR | Serbian (Cyrillic) | Serbian (Cyrillic) |
| ES | Spanish (Mexico) | Latin American |

To View the Keyboard Layout Mapping for a Specific Language
1. Open Microsoft Word or another text editor that supports the desired language.
2. Click the keyboard layout icon in the bottom-right section of the taskbar (two upppercase letters icon).
3. From the list, select the desired keyboard layout, the icon should update accordingly.
4. Click Start, Programs, Accessories, Accessibility, On-Screen Keyboard.
5. If necessary, repeat steps 2 and 3 again
6. The On-Screen Keyboard should now update with the characters from this language
7. Click on the desired key from the On-Screen Keyboard to input the desired character in the text editor
8. Close both the text editor and the On-Screen Keyboard when finished.

The following documents contain keys mapping for some languages:
Arabic-101.doc
Croatian.doc
Spanish.doc
Serbian-Cyrillic.doc
   8.F. Appendix F: Known Bugs
When creating or editing grammars, the “List” check box is always available, allowing grammars with invalid format to be checked as a “List”.
If you do a Full Export then a Full Import, and you do not overwrite you can create duplicate Topic names.
“Order Children” doesn't carry changes from GramEdit to S-Minds when ordering Topics.
After editing a question or an answer, using a mouse wheel in the Topics pane crashes GramEdit.
   Attachment B
   Speaking Minds—a Graphical Speech-to-Speech Translation System
   User Documentation—Version 1.5.0
   1. Overview
   1.A. Speaking Minds (S-Minds)

Speaking Minds is a speech-to-speech, two-way language translation system intended to aid in the process of interviewing people in a second language. It is organized in an intuitive question-answer style.

2. Installation

2.A. What You Need

At a minimum you will need the following.

Windows NT or 2000

A Pentium 11, 200 MHz CPU

128 MB of RAM

400 MB of hard disk space

A CD ROM drive

A high-quality microphone

A set of speakers

2.B. Installation Steps
Note the serial number specified on the CD before beginning the installation, which is written on the CD beginning with “S . . . ”.

Insert the CD into your PC.
Click on Start→Run on your Desktop, and then the “Browse . . . ” button. Click on the drop-down list Look in: to find the CD drive. Select the option next to the [symbol] . You should then see Setup.exe file; double-click on it. Click “OK” on the Run window. The InstallShield wizard will start up and lead you through the installation.
The first page is the welcoming page. Press Next. The second page shows the legal agreement. Press Yes.
Page three of the InstallShield wizard will ask you about the serial number. Enter the serial number that is specified on the CD.
Page four of the InstallShield wizard will ask you for the installation path. You can either install into the default path or browse for the different location. “S-MINDS” directory will be appended to your path if you don't specify it.
The last page of the InstallShield wizard will ask you to restart your computer. This step is VERY IMPORTANT for the fonts to work correctly. If you do not restart your computer, fonts will not install properly.
When installation is complete and the computer is restarted, check the installation by finding the Arial Unicode MS icon in your list of fonts. Open your Control Panel by selecting Start→Settings→Control Panel Menu. Double click on Fonts icon. A list of all installed fonts should appear. Find the Arial Unicode MS in the list of fonts.
   3. Running S-Minds

3.A. Getting Started

To run S-Minds perform the following steps.

Step 1—Make sure your microphone is on and working.

Step 2—Find the S-Minds shortcut on your desktop and double-click on it.

Step 3—The Speaking Minds splash screen should appear.

3. B. Setup Wizard

S-Minds must be configured each time it is run. At startup, the following three wizard screens will appear and must be configured.

a) Language Selection

You need to select a target language. This is the language that English will be translated into. Once you have made your selection, press the Next button. NOTE: Spanish, Arabic, Japanese, Korean and Serbo-Croatian (referred to as Serbo) have two-way recognition (i.e., recognize spoken English and translate to Spanish or named above languages, then recognize spoken Spanish, and translate into English). Chinese is one way only (i.e., recognize spoken English and translate into Chinese). To change the language selection, the system must be restarted.

b) Log File Selection

All session activity can be logged to a log file. If you do not want a log file, select No and press the Next button; otherwise select Yes and press Next. If you choose to log the session, a Save Log dialog will appear. Type in a log session name, which will be the directory name in the logging directory for S-Minds, S-Minds\Log, as well as the log file name. Press Save to save the log session name. If the log session name already exists, the Message dialog will appear asking if you want to append to the existing session. By pressing Yes, your activities will be appended to the session name directory you specified. By pressing No, you will be asked to select another session name. If you choose to have a log session, all utterances spoken to the system will be recorded into your log directory. Log files can be edited through the Log Editor (see 3.1, Log Editor).

c) Calibration

Calibration is necessary if recognition is to occur accurately. Press the Calibrate button and speak the phrase “Welcome to Speaking Minds” in your regular speaking voice. After a few seconds, a dialog window will appear asking you to adjust the input level if necessary. You can use the slider under the calibrate button to lower or raise the input volume. If that is not sufficient, adjust the microphone position. Once the calibration is “good,” press the Finish button.

3.C. Getting Recognition (Quick Start)

After the Setup wizard is completed, you can immediately start recognition. By default, a Topic (Greeting/Goodbye) and Subtopic (Greeting) have been selected. You can press the Speak English button and say “Hello, how are you,” and the system should translate it into your selected second language.

If you have selected a two-way language, you can now press the Speak Spanish (or Speak Serbo-Croatian) button and answer back “I am fine, thank you” (In the appropriate language, of course).

You can change a sub-topic by first double-clicking on a topics then single-clicking on a subtopics.

Once a subtopic is selected, you can ask any question that appears in the English Questions Samples pane. The question you speak does not have to exactly match the question on the screen. The system is programmed to accept many natural variations, e.g,. the displayed question, “Hello, how are you,” will recognize “Hi, how are you today.”

If you select a question, you will see a set of sample answers for it in the Spanish Answers Samples Pane. Again, these are just sample answers; most similar answers will also be recognized.

3.D. Main Display

The main display has a Menu Bar, a Tool Bar, and the following five default main panes.

Menu Bar, Tool Bar,

The Tool Bar allows quick access to features that are in the Menu Bar. The Tool Bar entries are as follows (from left to right): Cut, Copy, Paste, Print, Search for a Topic, Search for a Question or Answer, Annotate the Log File, Record a user, Display an image, Open an image, Save an image, Zoom in on an image, Zoom out on an image, Help: About Speaking Minds

a) (F5) Control Center Pane

This is the main control for the Speaking MINDS system (see FIG. 2). To have it recognize your English question, press the Speak English button and begin speaking. After you stop speaking, the system will recognize what you said and translate it into the second language. A text translation will be displayed on the screen, and an audio translation will be played out to the speaker. Second language recognition will work the same way. The current topic and subtopic are shown on the top of the pane. This will change as you select different topics from the Topics pane.
You can optionally disable the display of the translated text by selecting the
“View→Show Translation” menu item.

Recognition in English will not be available until a valid Subtopic is selected. Recognition in the second language will only be available after recognition has occurred in the first language, or when a valid question is selected from the Second Language Answers Samples Pane. If [Second Language] Answers Samples does not have an answer to a question after the recognition of a question, the Speak [Second Language] button will change to Recording (start), to enable the recording of an answer.

Depending on your computer set up, the Feedback Gain Display is on the right side of the question and answer text fields. This is a visual feedback on the level of the voice speaking into the microphone. If you do not see green scale appear in the display, the system cannot hear you. This display will not appear on all systems.

b) (F6) Topics Pane
1. This pane shows a tree hierarchy of topics and subtopics. A valid subtopic must be selected or recognition will not occur. (See picture below).

To view Subtopics, double-click on a closed topic (a topic with a (+) next to it) or single-click on the (+) next to the topic name. The list of subtopics will then appear beneath it. To hide the subtopics, double-click on an open topic (a topic with a (−) next to it), or single-click on the (−) next to the topic name. The list of subtopics will disappear, and the topic will be marked as closed (+).

By single-clicking on a subtopic, you will select it and the corresponding grammars will be loaded for the recognition. The English Questions Samples pane will be updated with the sample questions.

c) (F7) English Questions Samples Pane
2. This pane shows sample questions for the currently selected topic and subtopic. You can ask many questions shown in a more natural way. For example, question “Hi, how are you” can be asked as “Hello, how are you today.”

If you single-click on a question in this pane, a set of sample answers will appear in the [Second Language] Answers pane.

If you double-click on a question in this pane, the sample question will be played in the second language. If a question has answers, the Speak [second language] button will be enabled in the Control Center pane. If a question is a one-way question, the button will say Record (Start) to record an answer.

d) (F8) [Second Language] Answers Samples Pane, e.g., Spanish
3. This pane shows sample answers for the currently selected question. Any answer similar to the answer will be recognized.

e) (F9) Data Log Pane
4. This pane shows all questions and answers selected as well as text annotations being recorded into the log file. The selection of the topics and subtopics, opening and saving images and audio files will be also noted. You must start a log file to activate this pane (see 3H, “Creating a New Log File” below).

3.E. Recording Audio

To record a person's voice, select the “View→Audio Recorder” menu. The Audio Recording dialog will appear.

To begin recording, press the Record (Start) button. The button text will change to Record (Stop). You can begin speaking at any time after you press the button. When you are finished recording, press the Record (Stop) button. The button text will change back to Record (Start).

If you want to hear the recording you just made, press the Play button, and the recorded file will be played to you.

If you wish to save the recorded file, press the Save button, and a Save As dialog window will appear. The default file name will appear in the text field “File name:.” If you wish to change it, select the default file name and type the new name in the “File name:” field. Select the location to save to by clicking on the drop-down list of “Save in:” text fields. If you did not open a log, the default location to which the file will be saved will be S-Minds\log\[logname]\Audio. If you did open a log, the default location to which the file will be saved will be S-Minds\data\common\Audio.

To close the Audio Recording dialog window, press the Close button. If you forgot to save your recording, you will be asked to do so. After saving a recording, you can record and save another recording.

3.F. Displaying Images

To display images, choose the “View→Image Viewer” menu. The Image Viewer pane will appear. This will hide the main menu. To get back to the main menu, select either the “View→Image Viewer” again or the “Image→Close” menu.

Once the Image Viewer pane is open, you can display new images by selecting “Image→Open.” The Open dialog window will appear. Locate the image files, select the file name, and press the Open button. The default location for all image files is S-Minds\data\common\Image.

You can draw in an image by clicking and dragging the pencil pointer using the mouse. To save the image, select the “Image→Save” menu, and the Save As dialog window will appear. Choose the file name and location. By default, the image will be saved into the logging directory.

Open a blank page to create your own image by selecting the “Image→New” menu. Note that when the image is open, the recognition will still work by using F3 and F4 functional keys. (See section 3.J. Advanced Features)

3.G. Annotating the Log

If you previously chose to keep a log file, you can insert text comments into the log file. To open, select the “View→Text Annotation” menu. If you did not choose to have a log file, this option will be grayed out. The Text Annotation dialog window will appear.

Type your comments in the text field and press the Add button. The text you entered will appear in the Data Log pane. You can add repeatedly by entering more text and pressing the Add button again. When finished, press the Close button.

3.H. Creating a New Log File

If you wish to create a new log file and are currently not writing to a log file, select the “Options→Log Data to file.” A Log File dialog window will appear. The Record all utterances check box is always checked if you choose to keep the log (see Set Up Wizard, Log File Selection for explanation). Press the Yes button. A Save Log dialog will appear. Type the session name and press Save. The new log session directory and a file in the HTML format will be created in S-Minds\Log. If you entered the existing log session name, the Message dialog will appear. Press Yes if you want to append to an existing session. Press No if you want to choose a different session name. The Data Log pane, if visible, will update and logging will now occur.

To stop logging to an open log file select “Options→Log Data to file.” The Data Log pane, if visible, will be cleared of the old logging data. To restart logging, perform the steps described above.

3.I. Log Editor

If the information logged needs to be edited or corrected, log files are designed to be editable through the user-friendly interface. To edit your log file, make sure you closed the logging section as described in the section above or that S-Minds is shut down. To access log files, find where S-Minds is installed on your computer. Then, find Log directory and inside Log, find your log session directory. Inside the directory of your log session, double-click on the file named [your session name].html. You should see your logging information displayed in the editable format as shown in FIG. 9.

All recognized questions and answers can be played by clicking on the link “play” on the right of the translation text. The translation text can be changed according to the recorded utterance. If a question was played without the recognition by double-clicking the sample sentence in the English Questions Samples pane, the text is not editable because the text says exactly what was played. The text annotations are also not editable. The recorded answers for the one-way questions have empty text fields to be filled in after listening to the wave file. The images can be viewed by clicking on the link “view.”

After all modifications are made, press the Save Log button to save the changes. If you want to cancel changes you just made, press the Cancel Changes button. The editing can continue after you have saved once. Every time the log is edited, the log entry is made to indicate that the log file was edited.

3.J. Voice Navigation

As a true voice recognition system, the system allows you to browse the topics and subtopics tree by voice command. For how to set up topics and subtopics for the voice command, refer to GramEdit Users Manual, sections 4.B.e., “Add a New Topic Using Main Screen”, 4.B.f, “Add a New Subtopic Using Main Screen,” and 4.C.d., “Edit an Existing Domain, Topic and Subtopic Using the Main Screen.”

To select the topic in the tree, press the Speak English button and say, “Go to topic <name>,” and the first subtopic of the named topic will be selected in the tree. To change subtopics inside the topic, press the Speak English button and say, “Go to sub-topic <name>.” You can also browse subtopics of the current topic by saying, “Go to first” or “Go to last” or “Go to previous” or “Go to next.” If the current topic or subtopic is linked to another parent, the system first looks in the currently selected component. If not found, the first appearance is selected.

To find out what the current topic is, say, “Read current topic, ” and the system tells you the name of the topic. The same is true for a current subtopic; say, “Read current subtopic.” To find out what topics the current domain contains, say, “Read list topics,” and the system reads a list of all topics in the current domain. The same is true for a current topic; say “Read list subtopics,” and the system reads a list of subtopics in the current topic.

3.K. Advanced Features

a) Searching for Questions/Answers

To search for questions, select the “View→Search Phrase” menu, and the Search Phrase dialog window will appear as shown below. This dialog window allows you to search for keywords and phrases that are in the Speaking MINDS system and quickly load them for recognition and translation.

Type a keyword in the text field just above the Search button and press the Search button. A list of matching questions or answers will be displayed along with their topics and subtopics.

If you click on an entry, the main screen will update the Topics pane, showing you the Topics and English Questions Samples panes with sample questions, or [Language] Answers Samples pane with sample answers.

b) Searching for Topics

To search for a topic, select “View→Search Topic” menu, and the Search Topic dialog window will appear. It behaves just like the Search Phrase dialog except it only searches on topic and subtopic names.

c) Taking Pictures (for VAIO with the Built-in Camera)

This section describes how to use the Sony VAIO picture Book camera. On the top right side of the Sony, there is a silver button with the word “capture” next to it. Press this button. Note that the button has two depths, and you need to press to the second depth. There will be an audible click if you do this correctly. A few seconds after pressing the button, a Sony Camera control window will appear.

Aim and focus the built-in camera. To focus, turn the knob on the top of the camera. You should see what you are aiming at displayed in the camera control window. Once you are satisfied with your image, press the Capture button on the bottom right side of the window. This will bring up the Still Viewer window. From here, you can save the image by pressing the Save button. Select a directory and file name to Save As. You must save in Bitmap Format to view the image in S-Minds. After saving, delete the displayed image by pressing the Delete button. This will not affect the saved image. When you are finished with the camera, close the Still Image viewer window and the Capture window.

d) Recognition Modes

The default mode of operation for recognition is “Manual Mode.” This assumes that before speaking either language, you will press the Speak (language) buttons.

The system can automatically start recognition in the second language as soon as it finishes playing out the translation in the first language. Its mode is called “Toggle Mode.” To set the toggle mode, select the “Options—Toggle Mode.” This mode assumes the second language answer will follow the English question, so pressing the “Speak Second Language” button is automated for you.

The system can also continuously toggle between languages as recognition occurs. To set the continuous mode, select the “Options→Continuous Mode.” After pressing Speak English the first time, the system will continuously toggle to the opposite language after recognition occurs. To stop this mode, select another mode from the Option menu.

If the one-way question is asked in either Toggle or Continuous modes, the Speak Second Language button is changed to Recording (stop). This is because the system automatically starts recording an answer and requires user input to stop the recording. In the Toggle mode, after Recording (stop) is pressed, the Speak English button is enabled, and the normal Toggle mode behavior continues. In the Continuous mode, after Recording (stop) is pressed, the system expects English utterance, as it would after the recognition of the second language.

Modes can be switched without selection of the Options menu by pressing corresponding shortcut keys. To switch to the Manual mode, press Alt+M, to switch to the Toggle mode—Alt+T, and to switch to the Continuous—Alt+C.

e) Edit List Grammars

A list grammar is the grammar that lists simple options in its sub-grammars. For example, the sentence “I don't speak French” has grammar “(I don't speak $lang)” and $lang is the list grammar that lists different languages that can be used in this sentence “($French|$Spanish|$German|$Russian).” The list sub-grammars must be created in GramEdit in order to be modified in S-Minds. Please refer to GramEdit Users Manual documentation for the instructions on how to create a list sub-grammar. S-Minds provides the option of editing simple list sub-grammars on the fly without opening GramEdit; however, you will need some linguistic knowledge in order to edit list sub-grammars.

To edit a question list sub-grammar, select “Edit→Edit Question Lists,” and the Edit Question Lists window will appear as shown below. On the left side of the window, there is a Sub-Grammars list of all sub-grammars that can be edited. Select the one for editing, and the Items field will show all items in the selected list. The details of the first item will appear in the editing part of the window below Items. The editing part of the window shows the name of the sub-grammar in the Item field, the recognized text in the Text field, translation in the Trans field, and the wave file with the recorded translation in the Wave field.

To add a new item to the selected list, overwrite the Item, Text, and Trans fields with the details of the item you want to add. Record the translation by pressing the Record button (red circle) and stopping the recording by pressing the Record button again. Press the Play button (blue triangle) to listen to the recording. Press the Add button to add the new item to the list. The new item will be listed in the Items field.

To edit an existing item, select the item from the Items list, and the details of that item will be displayed in the editing part of the screen. Make changes to Item, Test, Trans, or Wave fields and press Update.

To delete an item, select the item from the Items list and press the Remove button.

To save changes, press the Save button. The compilation process will start, and the Dos compilation window will appear. Wait for the Dos window and Edit Question Lists window to disappear. The changes to the list will be saved, compiled and ready for recognition. If you don't want to save changes, press the Cancel button and the changes will be lost.

When editing or adding, some words that are being added in the Text field may not be in the dictionary. In this case, the dialog box will appear asking if you want to add these words to the dictionary. Please refer to the GramEdit Users Manual for the detailed explanation on how to add words to a dictionary.

The option “Edit→Edit Answer Lists” works the same as “Edit→Edit Question Lists” described above.

f) Function Keys

Pressing the function keys F3 through F12 will perform the following functions.
F3—alternative to the pressing the Speak English button on the Control Center pane. See “Control Center” description above.
F4—alternative to the pressing Speak [Language] button on the Control Center pane. See “Control Center” description above.

Function keys to activate panes and alternatives to the mouse click on the pane are:
F5—Control Center
F6—Topics
F7—English Questions Samples
F8-[Second Language] Answers Samples
F9—Data Log
F10—to view image, displays Image Viewer window, subsequent press of F10 hides the Image Viewer
F11—to start audio recording, displays Audio Recording dialog window
F12—to start text annotation, displays Text Annotation window
Ctrl+Tab switches focus between panes

g) Keyboard Navigation

In the main window, pressing the Alt Key reveals and enables shortcuts to the menu options. Shortcuts are marked by underlined letters as shown.

After pressing the Alt Key, you can select a menu item by pressing the underlined letter of each option using the Right Arrow Key [→] or Left Arrow Key [←] to navigate through the menus. The Up Arrow Key [↑] and Down Arrow Key [↓] navigate though the menu options.

In the Topics pane, the Shift plus Right Arrow Key [→] expands the topics tree showing all subtopics. The Shift Left Arrow Key [←] compresses the topics tree, hiding all subtopics. If the topic is highlighted, the Right Arrow Key [→] expands it showing subtopics, and the Left Arrow Key [←] compresses it. The Up Arrow Key [↑] navigates the topics tree up, and the Down Arrow Key [↓] navigates the topics tree down.

In the English Questions Samples and [Second Language] Answers Samples panes, the Up Arrow Key [↑] navigates up through the list of questions/answers, and the Down Arrow Key [↓] navigates down the list of questions/answers.

h) Help Menu

The Help menu option offers help about this software. Select “Help” menu option and you will see “Show help at startup” and “About Speaking MINDS.” If there is a check mark by the “Show help at startup” option, the help dialog box will appear when the system is started. If you don't want the help box to appear at the startup, uncheck this option. Select the “About Speaking MINDS” option, and you will see the window with the version, date, serial number, and short description information. When finished, press the “Close” button on the right side of the window.

4. Advanced Settings

4.A. Changing View

a) Changing the Layout

The layout of the main screen is completely configurable. To remove a pane, press the (X) button in the upper right corner of any pane.

A new pane can be added to the right of or beneath any existing pane. To add a pane beneath a current pane, first click on an existing pane on the screen and its title bar will be highlighted. Choose “Layout→Split Horizontal,” and a new empty pane will appear directly beneath the highlighted title bar.

An empty pane can house any of the panes available in the “Layout→Change Pane” menu. Just select the empty pane and then select an available (unchecked) pane from the “Layout→Change Pane” menu.

Try the example of changing the layout.
From the default layout, delete the [Language] Answers Samples pane by clicking (X) in its upper right corner.
Click on the highlighted English Questions Samples pane.
Select the “Layout→Split Vertical” menu. The highlighted new Empty pane will appear just to the right of the English Questions Samples pane.
Select the “Layout→Change Pane” menu; a list of all the pane names is displayed.
Select “Answers,” which should be unchecked. The Empty pane should now be replaced by the Answers pane.
If you wish to replace the contents of an existing pane, perform the following steps.
   Step 1: Open the “Layout→> Change Pane” menu.
   Step 2: Select the checked pane name you wish to replace. After selecting it, it will change to the Empty pane, and it will be highlighted.
   Step 3: Select the replacement (unchecked) pane from the “Layout→Change Pane” menu. It will fill in the empty pane with the selected pane.
To save your layout, you must select the “Layout→Save Layout” menu and then select “File→Save.” Otherwise, your new layout will be lost.
Below are examples of two different lay outs: the left has Questions and Answers panes side by side; and the right has Questions pane on the top of Answers pane and not Image pane.

b) Changing Text Color

You can change the color of the text in which questions, answers, topics, and subtopics are displayed. To change the text color, select “Options→Colors→Text,” and the Color window will appear. Select the color you want the text to be displayed in and press the OK button.

c) Changing Fonts

You can change both the general font and the font used to display the languages.

To change the general font, select “Options→Font (General),” and a font selection dialog will appear. This will change the font of everything in the window written in English except for language-specific text, namely English Questions Samples and [Language]Answers Samples panes.

Selecting “Option→Font (Languages)” will change the font of the English Questions Samples and [Language] Answers Samples panes. You must use a Unicode font to display Arabic or Chinese fonts. In addition, you may need to change the Script option in the font selection dialog to match your current language. NOTE: If you do not have the correct font for your language, no text will be displayed in the Control Center pane.

d) Saving Setup Options

To save the layout of the main window and the current selected topic, sub-topic, question, answer, choose “File→Save,” and the setup will be saved in the Setup.cfg file. The next time you start up the application, the main window will appear as you customized it. Remember to save the layout by choosing “Layout→Save Layout” before saving the setup.

The system by default loads the Setup.cfg file. If you save to another file name, the system will not load it by default.

If you saved the setup in the different file, you can apply it to the main window, by selecting “File→Open” and selecting the file that you saved your setup into.

If you do not save the setup, you will be asked to save it at the closing of the application.

4.B. Changing Initialization Options

The initialization file, Gram.ini, is located in the S-MINDS\Minds directory. This file specifies settings for the recognizers. S-Minds uses two recognition engines, SRI and Entropic. SRI can be used for English and Spanish and has better recognition accuracy. Entropic can be used for English, Spanish and Serbo-Croatian (Serbo) but is less accurate. The SRI recognition engine is bound by a license agreement with an expiration date of August 2002. The Entropic recognition engine is not bound by a license agreement and has no expiration date.

If the recognizer stops working, check the Gram.ini file, and in the [RECOGNIZERS] section find the specifications of engines. REC_NAME_{—}1 is the recognizer for English.

[RECOGNIZERS]
REC_NAME_1 = SRI
REC_NAME_2 = SRI
REC_NAME_3 = ENTROPIC
REC_NAME_4 = NUANCE
REC_NAME_5 = NONE
REC_NAME_6 = NONE
[SERIAL]
COM_DELAY = 0

REC_NAME_{—}2 is the recognizer for Spanish language. REC_NAME_{—}3 is the recognizer for Serbo-Croatian (Serbo) language. REC_NAME_{—}4 is the recognizer for Arabic. REC_NAME_{—}5 does not have recognizers because Chinese is a one-way language. The value for REC_NAME_{—}1, REC_NAME_{—}2, and REC_NAME_{—}3 can be either SRI or ENTROPIC or NUANCE, but there are preferred engines for each language. After the SRI license agreement has expired, you can try changing the value to ENTROPIC for all three languages, or contact Sehda.

COM_DELAY is the delay between receiving the RS-232 command to start the recognition and the playing of the audio beep. The default is 0 and the units are milliseconds.

4.C. Define Topics Shortcuts

The user can choose five favorite or most frequently used sub-topics and assign keyboard shortcuts to these sub-topics. The shortcuts allow quick switching to the chosen sub-topics, without using a mouse or voice command control.

To define the shortcuts for sub-topics, select the “Options→Topics Shortcuts” from the Menu, and the Topics Shortcuts window will appear. The key combinations to press is predefined and shown on the left-hand side of the dialog. To choose a favorite sub-topic, simply select the desired topic and sub-topic name from the drop-down list. An empty selection indicates that no sub-topic has been chosen, so this shortcut key is ignored. By pressing OK button, all changes will be saved and applied. Click Cancel button to exit this dialog without making any changes.

4.D. Audio Feedback

The default audio feedback setting is disabled for the S-Minds system. This is a toggle setting. To enable this feature, choose “Options→Audio Feedback”. A check mark next to the menu option indicates it is selected. Select this option again to disable. The default shortcut Alt+A can be used to enable or disable this feature.

When enabled, an audio prompt is played to indicate to the speaker that the system is ready to listen. Another prompt is played in case of a failed recognition. This feature is especially useful when the S-Minds is setup for remote use, and there is no computer screen with visual feedback.

4.E. Remote Use

S-Minds can optionally be used through a remote interface i.e. an operator does not need to be directly in front of the computer. S-Minds can be controlled via a serial port. This control feature is by default off and must be activated form the Options menu in order to work. In addition, an external hardware unit that can interact with S-Minds must be connected and configured properly.

a) Enabling Serial Port Interface

To allow S-Minds to communicate to a peripheral device, select “Options→RS-232 Interface”, a check mark will appear next to this option. To disable, select the same option again. The shortcut keys Alt+I will also toggle the interface on and off.

To make sure all audio signals are going through the Audio Box, select USB Audio Device as the preferred audio device by doing the following: a) from Start menu choose “Settings→Control Panel→Sounds and Multimedia Properties, choose the “Audio” tab; b) in the Sound Playback and Sound Recording partitions, locate the Preferred Device: selection; and c) choose USB Audio Device.

When enabled, it is possible to send and receive pre-defined commands (ASCII characters) on the RS-232 interface. Selecting this option will enable or disable both the RS-232 Control interface and the RS-232 Feedback interface at the same time. To separately select either one, you must use the RS-232 Options dialog described below.

b) Resetting Serial Port Interface

If there is miscommunication between the S-Minds system and a peripheral device, the reset option is available. By choosing “Options→RS-232 Reset”, or pressing the shortcut Alt+R, S-Minds will disconnect and reconnect the communication channel to the RS-232 interface.

c) Changing Serial Port Options

The choice of a communication port and communication protocol can be adjusted for a particular setup.

To change RS-232 options, select “Options→RS-232 Options”, or use Alt+O, and the RS-232 Options dialog window will appear as shown below.

By default, S-Minds uses COM1 port for communication. This setting can be changed by selecting the desired COM port from the dropdown list (COM 1 to 4).

The two check boxes correspond to the two communication channels defined in the system—RS-232 Control interface and RS-232 Feedback interface. RS-232 Control interface defines a set of commands received from the serial port that the software accepts and understands. RS-232 Feedback interface specifies a set of signals that the S-Minds system will send on the serial port. By checking these boxes, the communication channels are enabled. One-way communication is possible by checking only one of the boxes.

When the RS-232 Control interface is enabled, the software will execute the appropriate Shortcut Key in response to any of the twelve recognized commands, which are the following ASCII characters:

| | | | | | | | | | | | |
|---|---|---|---|---|---|---|---|---|---|---|---|
| 0 | 1 | 2 | 3 | 4 | 5 | 6 | 7 | 8 | 9 | * | # |

This relationship between the Shortcut Keys and the ASCII characters is shown below in the “Commands→Shortcut Keys” box of the RS232-options dialog window.

When RS-232 Feedback interface is enabled, the software will send the designated commands in response to certain actions in the software. Those feedback commands are the following ASCII characters:

| | |
|---|---|
| E | Start of English recognition |
| e | End of English recognition |
| F | Start of Foreign recognition |
| f | End of Foreign recognition |
| S | Success of recognition |
| X | Failure of recognition |

When S-Minds is used remotely, without any visual feedback, shortcut keys become an important method for communication. To change mapping of commands to shortcut keys, locate the “Commands to Shortcut Keys” section of the RS-232 options window. The commands recognized by the software are (‘0’ to ‘9’, ‘*’ and ‘#’) and listed on the left. To choose a Shortcut Key for each command, simply move a cursor into the box on the right side of the desired command, and press keys, as they would normally be pressed to activate the corresponding function in the software. The item “None” indicates that no keys have been chosen, so this command is ignored. Remember that a set of valid Shortcut Keys is already associated with some existing functions in the software (and are visible in the menu of the main window). A valid shortcut key must be entered for the command to actually perform an action.

When all changes are complete, click “OK” button to save, apply all changes and exit the dialog window. Click “Cancel” button to exit without making any changes.

Some versions of Audio Box have an external speaker, which can be turn on and off by pressing both white and gray buttons together. It could also be always on without any loss to communication. All necessary recordings are played to both speakers in their corresponding headphones.

4.F. Audio Box Installation

When the Audio Box is plugged in for the first time in an USB connector on your computer, Windows will automatically detect a new hardware device and ask to install a driver for it. Inside the Audio Box there is an USB-to-Serial converter device, which is used to send commands between the Audio Box and the computer. NOTE: if you are receiving hardware from Sehda Inc., all drivers are already installed.

To make sure all audio signals are going through the Audio Box, select USB Audio Device as the preferred audio device by doing the following: a) from Start menu choose “Settings→Control Panel→Sounds and Multimedia Properties, choose the “Audio” tab; b) in the Sound Playback and Sound Recording partitions, locate the Preferred Device: selection; and c) choose USB Audio Device.

Follow the installation instructions in the file located in S-MINDS\Drivers\GUC232A\GUC232A.PDF. Please note, that you should install the Windows XP driver in S-MINDS\Drivers\GUC232A\WINXP even if your computer runs Window 2000. But if you are unable to you choose the WINXP directory at this point, just click Cancel. In this case, from Start menu choose “Settings\Control Panels System”, and then choose the “Hardware” tab and the “Device Manager” button. Double-click on the “ATEN USB to Serial Cable (COM?)” device (see details below). Then click Reinstall Driver and try those steps again. You may have to restart your computer after the installation is completed.

If necessary, read again the previous section (4.E. Remote Use) of the S-Minds user's manual (the filename is S-MINDS\Documentation\S-Minds_Users_Manual.doc) for more details about the Serial Port configuration. But with the Audio Box, there are only two buttons and therefore two commands, so you should make sure to assign command 0 to shortcut F3 (Speak English) and command 1 to shortcut F4 (Speak Foreign Language). Make sure that the proper COM port is selected. You can verify this by looking in the Windows “Device Manager”. Expand the Ports section and look which COM port has been assigned to the device “ATEN USB to Serial Cable (COM?)”.

Appendix A: Sample S-Minds Demo

1. Getting Started

Find the S-Minds shortcut on your desktop and double-click on it.
   5. Setup Wizard
a) Language selection: select Spanish and press Next.
b) Log file selection: select Yes and press Next; in the Save Log window, type a unique log session name; press Save to save the log session name; log files will be saved in the S-Minds\Log directory.
c) Calibration: press Calibrate and say “Welcome to Speaking Minds” in your regular speaking voice; once the calibration is set, press Finish.
   3. Sample Interview
Make sure the topic Greeting/Goodbye and subtopic Greeting are selected in the Topics pane.
Press Speak English and say “Hello, how are you.”
Press Speak Spanish and say “Bien gracias.”
Press Speak English and say “This machine will let us talk together.”
Press Speak English and say “Do you understand me.”
Press Speak Spanish and say “Si lo entiendo.”
Change the topic to Personal Info and subtopic to Personal Info and Id.
Press Speak English and say “What is your name.”
Press Recording(start) and record the answer “Julio Gonzales,” then press Recording(stop).
Press Speak English and say “What is your nationality.”
Press Speak Spanish and say “Norteamericano.”
Press Speak English and say “How old are you.”
Press Speak Spanish and say “8 anos.”
Press Speak English and say “Where were you born.”
Press Recording(start) and record the answer “Cabo San Lucas,” then press Recording(stop).
Change the topic to Pictures and subtopic to Maps.
Press Speak English and say “Can you show me the location on a map.”
Press Speak Spanish and say “Si puedo mostrarle el lugar.”
Highlight Image Viewer; from the Menu bar, select Image→Open, and then select “Croatia political map.bmp.”
Double-click on the question “Can you point to the location”
Press Speak Spanish and say “No.”
   4. Viewing Log File
Close the log file by selecting “Options→Log Data to file.” In the S-Minds/Log/[your logging name] directory, double-click on the file “your logging name.html.”
   Appendix B: Known Bugs
Log Editing tool works only if log file is closed properly. If log file is viewed while a log is still in session, editing cannot be saved.
In the list grammar editing, lists cannot be empty.
If using Entropic for the second language recognizer and logging is enabled, wave files are saved in the Motorola format that is not supported by Windows Media Player, and therefore have to be converted for using in Log Editing tool. The conversion fails sometimes.
If one-way question is recognized in Toggle or Continues modes, the recording of an answer is started and is waiting for the user input to stop. If a question or different sub-topic is selected from the main screen before recording is stopped, “Error Starting Recognition” is thrown. To recover, restart the system.
When recording one-way question, the menu bar is enabled, and therefore, any operation from the menu bar during the recording breaks the system. To recover, restart.
Full Import does not import properly if the nested sub-grammar is changed.

While the present invention has been described with reference to certain preferred embodiments, it is to be understood that the present invention is not to be limited to such specific embodiments. Rather, it is the inventor's contention that the invention be understood and construed in its broadest meaning as reflected by the following claims. Thus, these claims are to be understood as incorporating and not only the preferred embodiment described herein but all those other and further alterations and modifications as would be apparent to those of ordinary skilled in the art.

We claim:

1. A translation system, comprising:
one or more input devices;
a grammar database having a plurality of semantic tags;
one or more speech recognition engines connected to said input devices and said grammar database, wherein one of said speech recognition engines receives speech input from one of the input devices and matches said input with one or more semantic tags from said grammar database to generate matched semantic tags; and
a translation generator for generating translation output based on said matched semantic tags and said grammar database.
